(19) United States
(12) Patent Application Publication
(10) Pub. No.: US 2008/0177836 A1
(43) Pub. Date: Jul. 24, 2008

(54) Method and system for managing health and wellness programs

(75) Inventor: Joel B. Bennett, Fort Worth, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: Organizational Wellness & Learning Systems, Inc., Fort Worth, TX (US)

(21) Appl. No.: 11/656,637

(22) Filed: Jan. 23, 2007

(51) Int. Cl. G06F 15/16

(52) U.S. Cl. 709/205

(57) ABSTRACT

A system and method are provided that include a health and wellness system that includes a network configured to provide one or more members of an organization access to the health and wellness system, a web server configured to provide a plurality of web pages over the network, and a plurality of wellness programs. A survey that has a plurality of health and wellness categories is delivered to the one or more members via the plurality of web pages. The one or more members provide a response to the survey that has a plurality of numerical scores for each of the plurality of health and wellness categories. Each of the plurality of wellness programs are configured to improve the health and wellness in at least one of the plurality of health and wellness categories for at least one of the one or more members. Each of the plurality of wellness programs have a predefined numerical equation for each of the plurality of health and wellness categories. One or more of the plurality of wellness programs are identified in a readable format via the plurality of web pages by comparing results from the predefined mathematical equations using the numerical scores as input.

### BACKGROUND OF THE INVENTION

1. Field of the Invention

The present invention relates to management of health and wellness programs and more particularly to a system and method for managing health and wellness programs.

2. Discussion of the Background

Organizations often have a need to correct and/or improve the overall health and productivity of their employees and of the work climate of the organization. Many health and wellness programs have been developed to aid organizations in making such corrections and/or improvements. However, these health and wellness programs are generally oriented toward individuals with little or no focus on making such corrections and/or improvements to the health and productivity of the work climate in general and as a preventive measure. Further, the emphasis, effectiveness and delivery formats of these health and wellness programs varies widely. In particular, due to their emphasis, most programs are designed to handle some aspects of an organization's overall needs better than other aspects. Thus, organizations are often required to utilize more than one program to correct all of their needs. Further, because of the variance of the health and wellness programs, it is often difficult to make unbiased comparisons between the programs.

Human resources departments and, most commonly, human resources managers, as well as the health insurance and risk management brokers who advise them, are typically required to carefully review the many health and wellness programs and make their own assessments based on their knowledge of the needs of the organization. Unfortunately, such self-assessments and the programming that follows are often flawed because (i) they do not include sufficient statistical analysis or objective measures to find the most appropriate program to solve the particular needs of the organization, (ii) they do not consider the level of readiness or preparedness of the organization for wellness or prevention programming, and (iii) they do not consider, or attempt to enhance, the competency of the human resource professional who is tasked with managing the program. Further, the person making the self-assessment often does not have a complete and/or accurate view of the overall health and productivity work climate of the organization as might be better ascertained through inquiry or data aggregation of a fair proportion of the members of an organization. Finally, many of these health and wellness programs have been developed without a basis in scientific evidence. This is often problematic because, as in other areas of the healthcare industry such as pharmaceuticals, there are often requirements and regulations for clinical trials and/or evidence-based demonstrations of product/program effectiveness. Such requirements provide a standardized basis for quality control and assurance which is typically lacking within the health and wellness industry. Accordingly, the most appropriate health and wellness programs and, specifically, those programs that have a greater chance of success, are often not selected.

Thus, as noted above, there currently exists deficiencies in selecting and evaluating health and wellness programs that are known in the prior art.

### SUMMARY OF THE INVENTION

Accordingly, one aspect of the present invention is to provide a health and wellness system that includes a network configured to provide one or more members of an organization access to the health and wellness system, a web server configured to provide a plurality of web pages over the network, and a plurality of wellness programs. A survey that has a plurality of health and wellness categories is delivered to the one or more members via the plurality of web pages. The one or more members provide a response to the survey that has a plurality of numerical scores for each of the plurality of health and wellness categories. Each of the plurality of wellness programs is configured to improve the health and wellness in at least one of the plurality of health and wellness categories for at least one of the one or more members. Each of the plurality of wellness programs has a predefined mathematical equation for each of the plurality of health and wellness categories. One or more of the plurality of wellness programs are identified in a readable format via the plurality of web pages by comparing results from the predefined mathematical equations using the plurality of numerical scores as input.

Another aspect of the present invention is to provide a method for providing a health and wellness program to members of an organization. The method includes maintaining a web server configured to provide a plurality of web pages over a network, defining a mathematical equation in each of a plurality of health and wellness categories for each of a plurality of wellness programs, providing a survey for each of the plurality of health and wellness categories to the one or more members via the plurality of web pages, receiving a response, having a plurality of numerical scores for each of the plurality of health and wellness categories, to the survey from the one or more members, comparing results from the mathematical equations using the plurality of numerical scores as input, identifying in a readable format one or more of the plurality of wellness programs via the plurality of web pages based comparison, and delivering at least one of the identified programs to at least one of the one or more members. Each of the programs is configured to improve the health and wellness in at least one of the plurality of health and wellness categories for at least one of the one or more members.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIGS. 1 and 2 are block diagrams illustrating the overall system according to an embodiment of the present invention;

FIGS. 3-6 are flow charts generally illustrating the overall system functionality according to an embodiment of the present invention;

FIG. 7 is a flow chart generally illustrating the system functionality with respect to assigning and adjusting weights within a survey system to discriminate between programs according to an embodiment of the present invention;

FIG. 8 is a block diagram illustrating the survey profile manager according to an embodiment of the present invention;

FIG. 9 is a chart depicting exemplary weightings associated with several health and wellness programs in each of several health and productivity climate (HPC) dimensions according to an embodiment of the present invention; and

FIGS. 10-35 illustrate an exemplary computer program for assessing, designing, delivering and evaluating a set of tools used in health and wellness areas according to an embodiment of the present invention.

### DETAILED DESCRIPTION OF THE PREFERRED EMBODIMENTS

In general, the present invention may include several primary functions including, without limitation, (i) assessing risks in the work climate of an organization, (ii) designing and/or selecting one or more health and wellness programs that are designed to address those risks, (iii) delivering one or more health and wellness programs to improve the health and productivity climate of the organization, and (iv) evaluating one or more health and wellness programs. The evaluation may be performed either proactively in an estimated fashion or consequently to the program delivery. The present invention may also include a set of e-learning modules that assist the user in learning each of the primary functions identified above. It is to be understood that less or more primary functions are within the present invention and that the present invention is not intended to be limited to the primary functions identified above. Each of the above-identified functionality and/or any tools therein may be used independently or in conjunction with each other.

Each of the primary functions may also include a set of tools to maximize the potential for effectively reducing identified risks, rather than merely addressing only one of the functions and/or only one set of tools within the primary functions. It is to be understood the set of tools does not comprise the full universe of tools that could be identified within each of the primary functions. Each primary function may include user interactivity and/or inputs and outputs for the user as a means of enhancing their ability to provide effective health and wellness programs.

The assess function may provide the user the ability to assess the level of organizational readiness for health and wellness programming. The assessment may occur through a survey (with inputs and outputs) that guides the user with feedback designed to enhance readiness for health and wellness programs. The assess function may also include a tool for assessing the levels of risks and strengths within the health and productivity climate of the organization to provide feedback on risks and strengths and to make recommendations on which health and wellness programs might be useful in reducing risks.

The design function may include a library that includes information, resources, and/or programs for two or more health and wellness programs that may be identified in the assess function. The design function may also provide the user the ability to determine which health and wellness program in the library may be most suitable given the logistics, format, and other tactical considerations as perceived by the user.

The deliver function may provide the user the ability to determine which strategy or set of strategies will optimize the health and wellness programs having an impact on the work climate and not only an impact on the individual health of workers either singularly or in aggregate. The deliver function may also provide the user the ability to design a plan for delivering the health and wellness programs in ways that consider location, schedule and target audience.

The evaluate function may provide the user the ability to estimate return-on-investment (“ROI”) for delivery of health and wellness programs, using an ROI tool. A ROI tool may include information from results of the climate survey (as indicated in the assess function) as well as information that integrates information on the disease burden of at least one of each of cardiovascular, mental health, and substance abuse disorders. In addition, the ROI tool may include information on the replacement value of workers. The evaluate function may also provide the user access to various evaluation forms that afford the user the ability to assess the impact of any selected, configured, or newly developed health and wellness program.

The e-learning modules may include tools designed to help the user assess his or her (i) self-perceived level of effectiveness, (ii) self-perceived approach to prevention program, (iii) ability to estimate climate risks given presentations of workplace case studies/scenarios depicting those set of risks.

Referring now to the drawings, wherein like reference numerals designate identical or corresponding parts throughout the several views, preferred embodiments of the present invention are described.

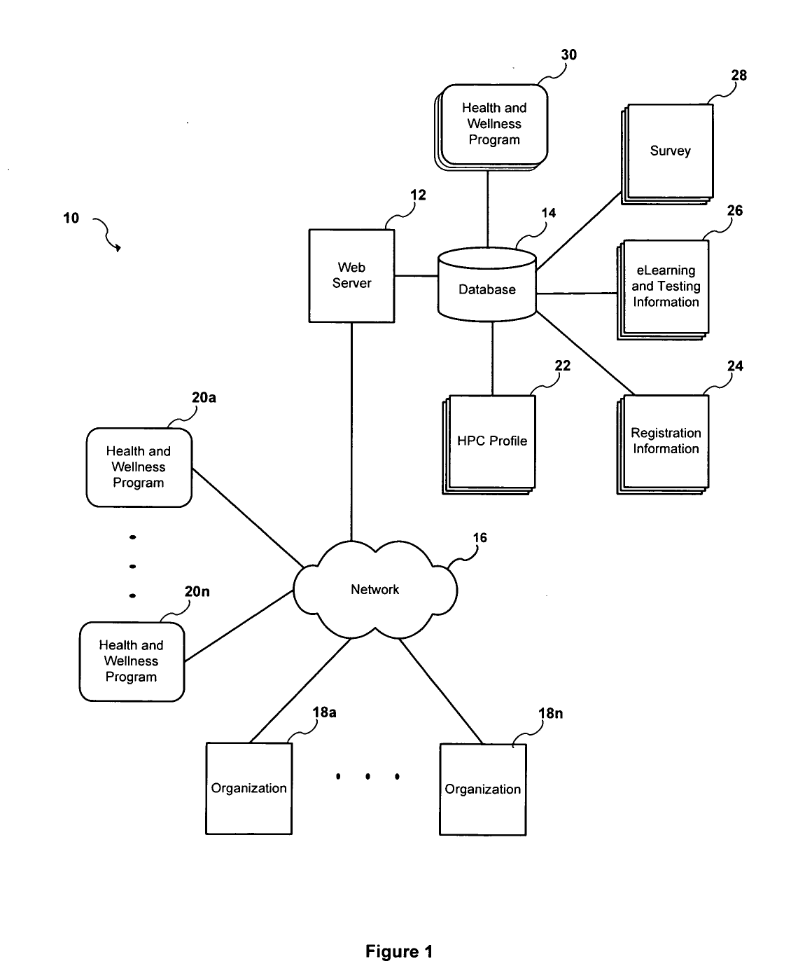

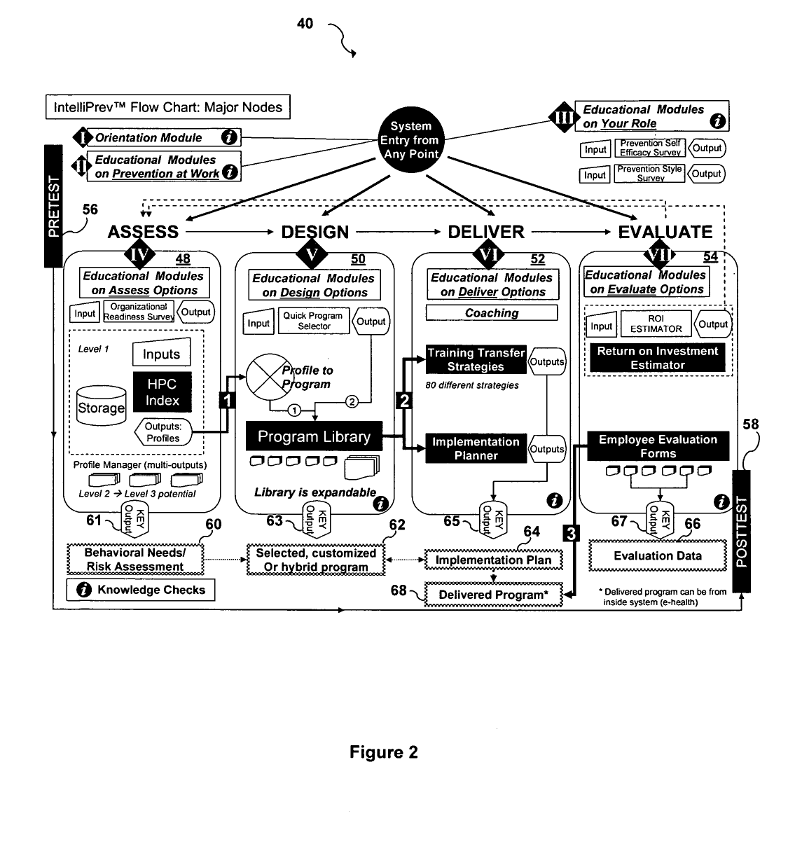

Referring to FIGS. 1 and 2, block diagrams illustrating the overall system 10 according to an embodiment of the present invention are shown. The present invention relates to a system and method for managing health and wellness programs using a computer program designed to be used by those who are involved in creating and/or sustaining a healthy workplace and members of an organization. It is to be understood that the term “organization” as used herein represents a distinct entity, as defined by a user (e.g., the administrator or primary contact), and may include any one or more of a number of worksites, departments, regions, or specific work groups identifiable within each of those designations or the organization as a whole or by virtue of location, occupation, or any other identifiable aspect of work whereby two or more individuals share membership. It is further to be understood that the term “managing” as used herein may include, without limitation, (i) assessing risks in the work climate of an organization, (ii) designing and/or selecting one or more health and wellness programs that are designed to address those risks, (iii) delivering one or more health and wellness programs to improve the health and productivity climate of the organization, and/or (iv) evaluating one or more health and wellness programs. The system 10 includes a computer or other hardware executing a web server 12. The web server 12 is in communication with one or more databases 14 containing health and wellness related information. For instance, the one or more databases 14 may include, without limitation, a Health and Productivity Climate (“HPC”) profile information 22, registration information 24, eLearning and testing information 26, surveys 28, and information relating to health and wellness programs and/or the actual program. One or more organizations (18a-18n) are in communication with the web server 12 over a network, including without limitation, the Internet 16, Intranet or other compatible network. One or more organizations (18a-18n) utilize the web-based system to design and deliver an appropriate set of health and wellness programs (20a-20n) based on a set of factors in several categories, including, without limitation, “Health & Wellness,” “Work-Life Balance,” “Presence and Engagement,” “Team Communication,” “Policy and Accountability,” “Coping with Stress,” and “Help & Support.” In one embodiment, the web-based system may be used to correct and/or improve the productivity and mental, emotional, or social wellness of an employee as well as improve the health of a particular work group, work department, or organization. The web-based system also provides analysis tools used in evaluating the performance of the programs.

The present invention is generally based on the following concepts: assess, design, deliver and evaluate, as respectively shown in blocks 48, 50, 52 and 54. The health and productivity work climate of an organization is initially assessed via survey, as shown at block 48, using what is collectively known as the “Health and Productivity Climate Index™” or “HPC Index™”. Optimally, the assessment occurs before problems become costly or critical, but may occur at any time. The assessment includes computing intermediate numerical scores based on responses provided during the assessment, and generating an organizational profile, known as an “HPC profile,” using the intermediate numerical scores. The HPC profile is grouped into several predefined health and wellness categories, known as “HPC climate dimensions.” The HPC profile may be graphically represented to the user. Next, a program is designed based on the assessment, as shown at block 50. The design includes selecting from a suite of health and wellness programs designed to correct and/or improve the overall health and productivity work climate of the organization and/or address one or more of the set of risks identified in the HPC profile. The suite of health and wellness programs is collectively known as the “IntelliPrev™ Library.” Based on the design, one or more health and wellness programs are delivered to the organization from the IntelliPrev™ library, as shown at block 52. The delivered programs are optionally evaluated for their effectiveness, as shown at block 54. The effectiveness of the delivered programs may be evaluated using any known means, including, without limitation, the financial return and/or reductions in cost to the organization attributable to the delivered programs compared with the initial investment to deliver the programs. The amount of money an organization can expect to save from delivering the programs may also be computed in advance of delivering such programs. Beyond the above identified concepts, the present invention also offers multimedia options, storage of multiple users' information, report generation from multiple users, coaching, and interactive education.

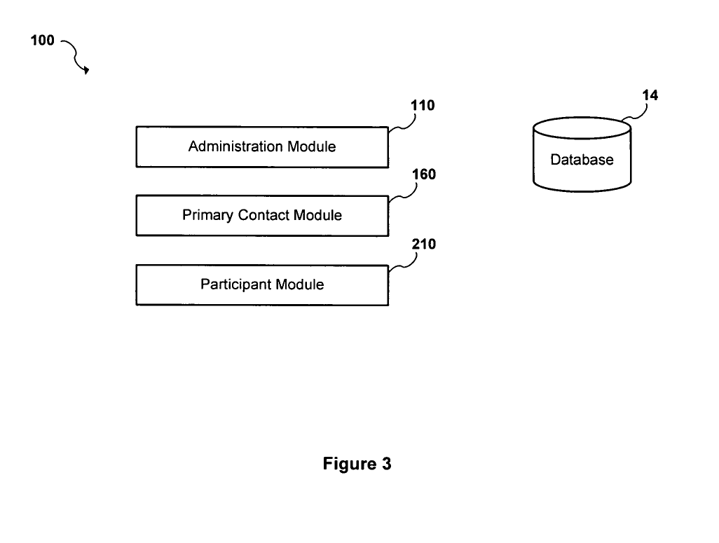

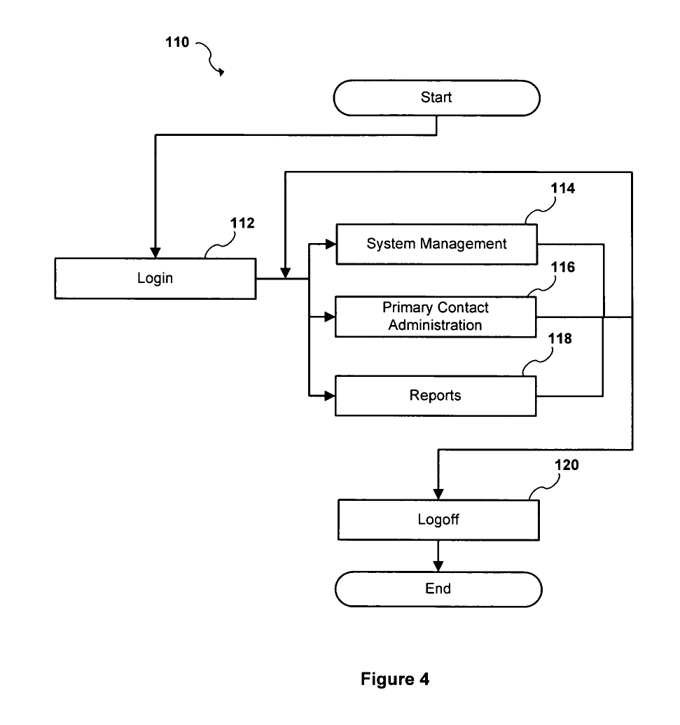

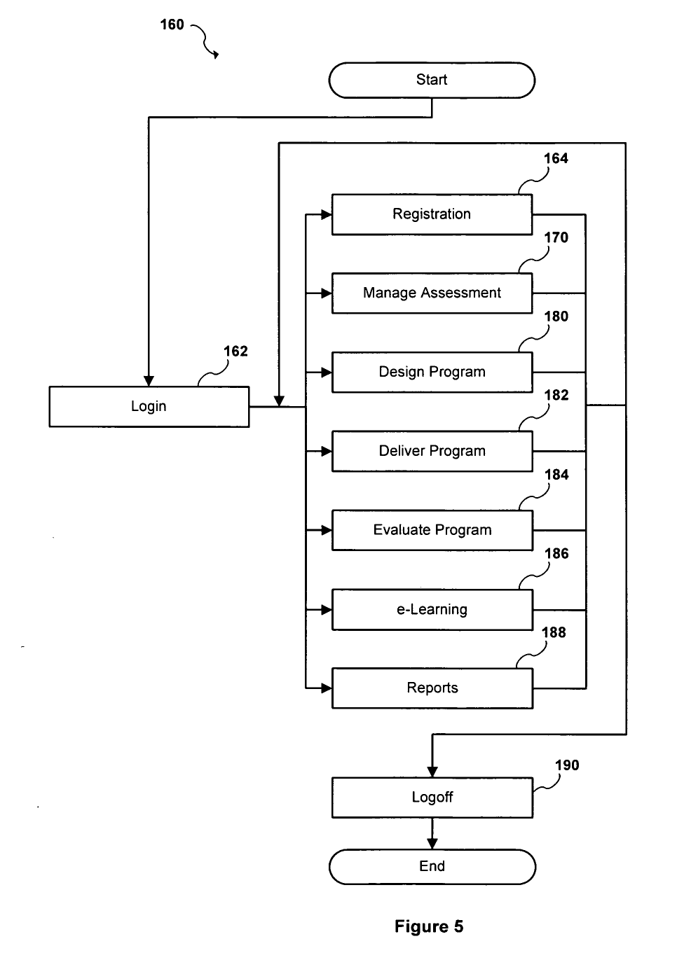

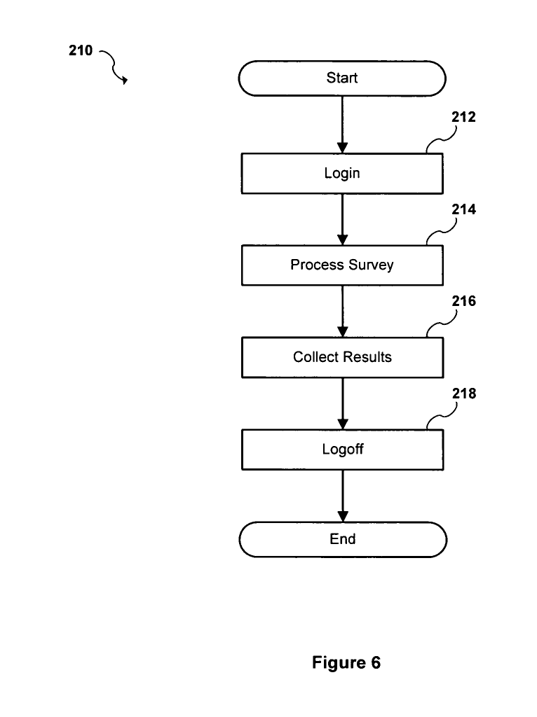

Referring to FIGS. 3-6, flow charts generally illustrating the overall system functionality according to an embodiment of the present invention are shown. The functionality of the present invention may be viewed as several different functional modules, including, without limitation, an administrative module 110, a primary contacts module 160 and a participant module 170. However, it is to be understood that the functionality of the present invention as illustrated in FIGS. 3-6 is for illustrative purposes and that other arrangements are possible within the of scope the present invention. Administrative module 110, primary contact module 160 and participant module 170 may be integrated using any known means, including, without limitation, one or more databases 14, ASCII files, cookies or session variables.

### Administrative Module

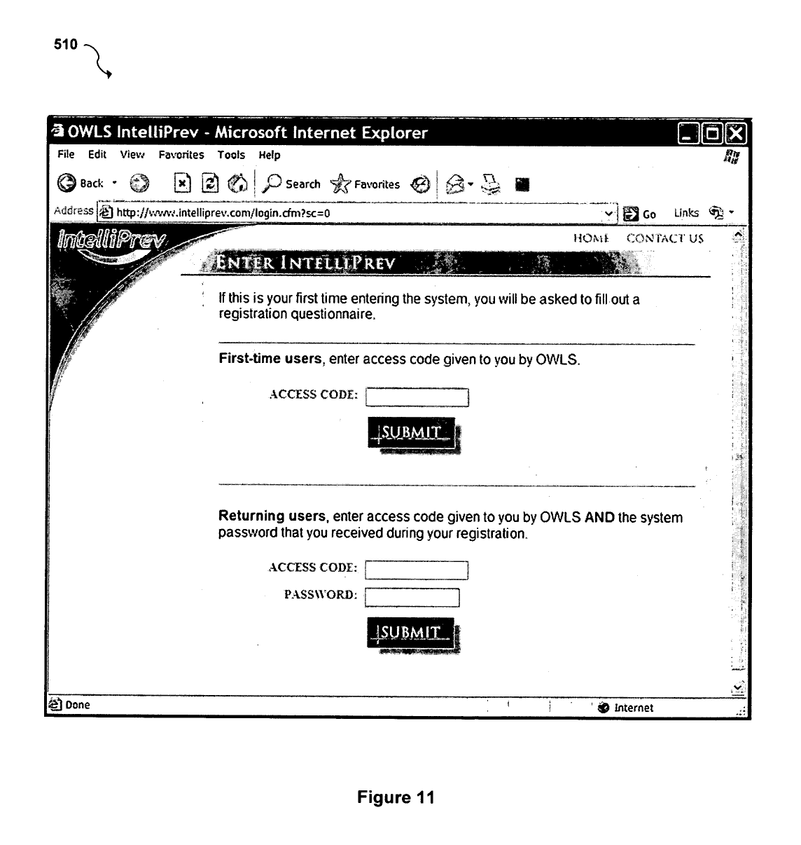

As shown at block 112, an administrative user logs in to the system. This step may include presenting the administrative user with a form that includes a username and password, and then authenticating the entered information. The form may comprise, without limitation, an HTML form, an XML form or a Flash form. For example, the administrative user may be presented with the web page shown in FIG. 11. The administrative user may either perform system management duties 114 or primary contacts administration 116 or generate one or more reports 118. Primary contact administration 116 includes managing the primary contacts by assigning and tracking the primary contact logins. Report generation 118 allows the administrative user to view information related to primary contacts and to view the aggregated results for an organization. As shown at block 120, the administrative user logs off the system and exits the system.

### Primary Contacts Module

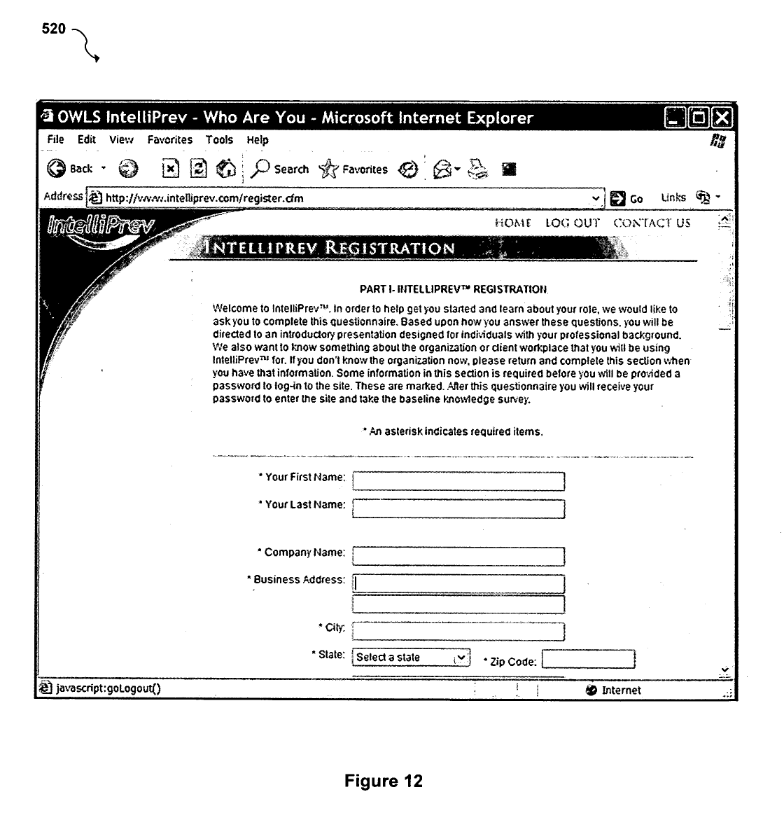

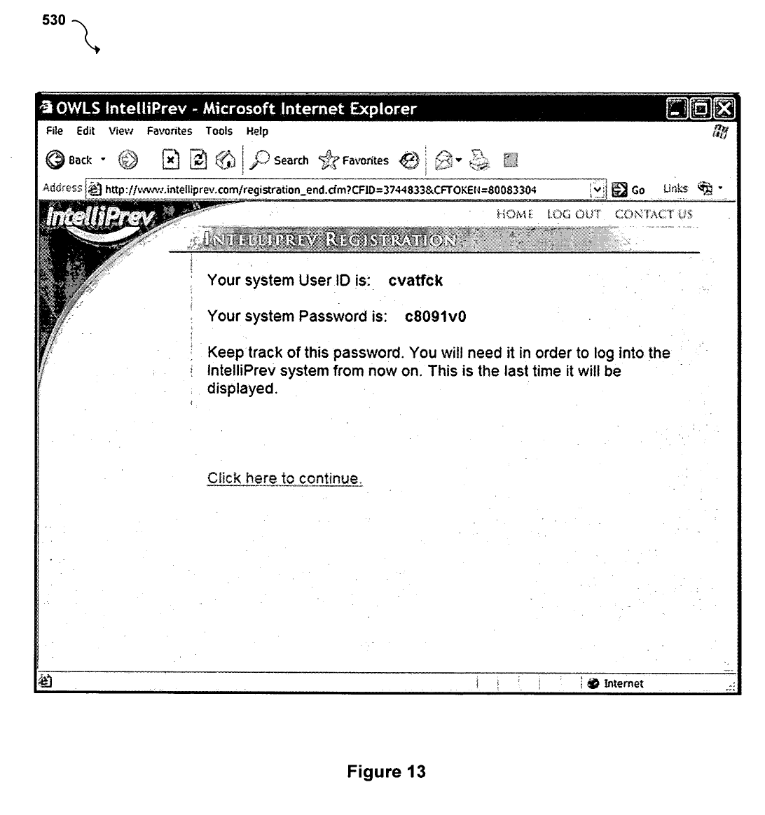

As shown at block 162, a user, typically referred to as a “primary contact” for a representative organization, initially logs in to the system. Here the user may be the primary contact or the system administrator or operator of the system. This step may include presenting the user with a form that includes a username and password, and then authenticating the entered information. As shown at block 164, the user may be presented with a brief questionnaire designed to provide registration information to the system. For example, the user may be presented with the registration web page shown in FIG. 12. This registration information may be stored by any known means including, without limitation, one or more databases 14 or ASCII files. In one embodiment, a password is generated and provided to the user during the registration process. For example, the user may be provided a password as shown in FIG. 13. Thereafter, the user logs in using the new password.

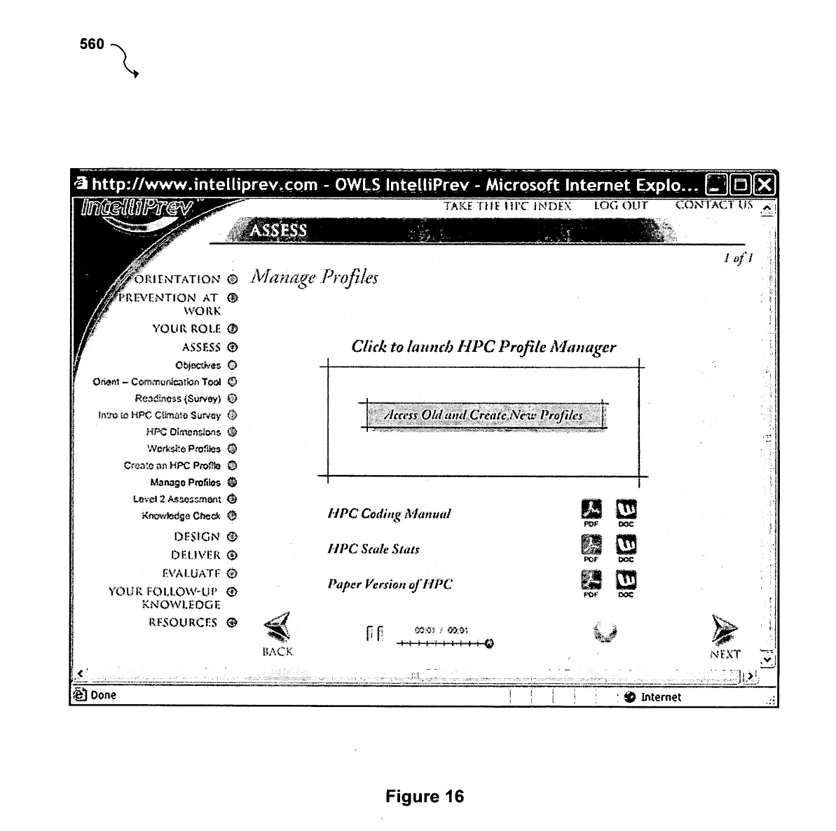

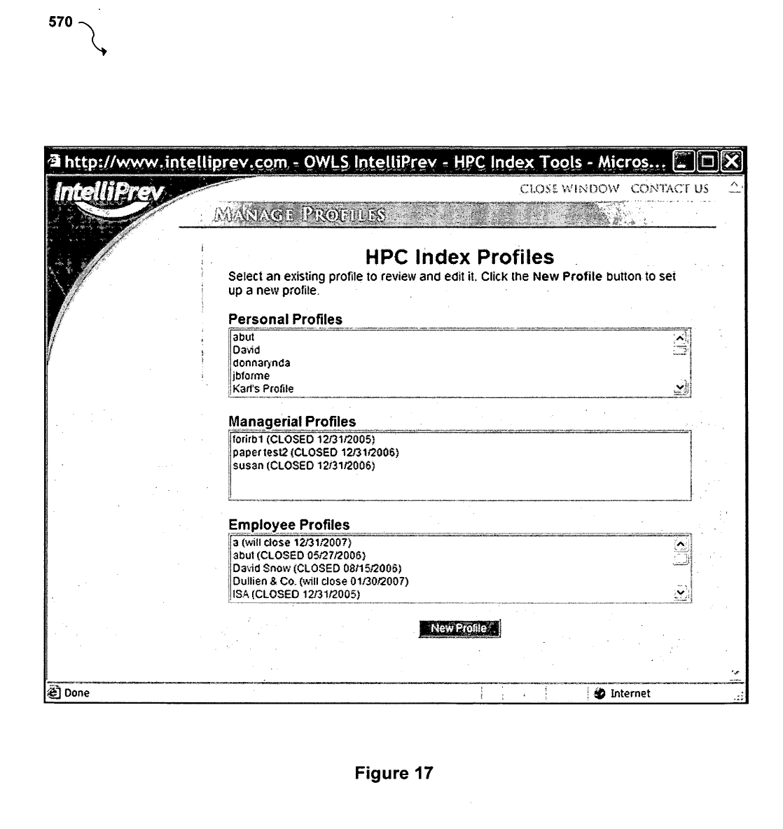

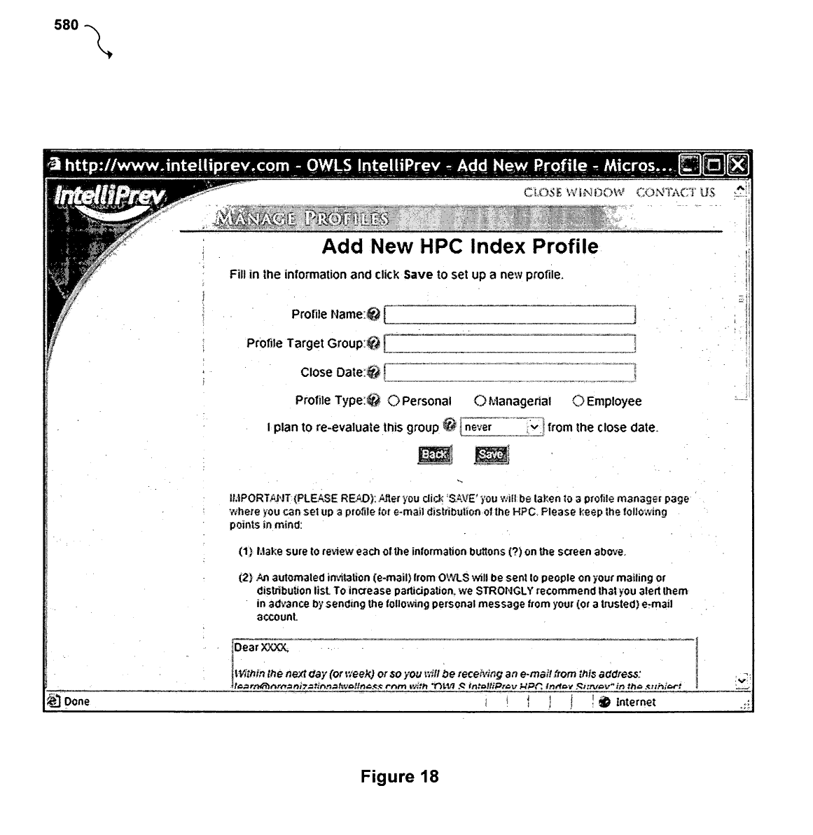

As shown at block 170, the user may choose to manage an assessment. This step includes creating, storing and/or managing one or more HPC profiles. For example, the user may manage one or more HPC profiles using the web pages shown in FIG. 16-18. Several types of HPC profiles may be configured, including, without limitation, personal, managerial and employee. Personal HPC profiles are used to obtain a user's personal view of the health and productivity work climate of the organization, whereas, managerial and employee HPC profiles are used to obtain the view of an entire group of members of an organization or target worksite. In one embodiment, during the management of one or more HPC profiles, the user is presented with a list of existing HPC profiles. The user either selects one of the HPC profiles on the list to manage or creates a new profile. Profile information includes, without limitation, a name, a target group, a close date and a profile type.

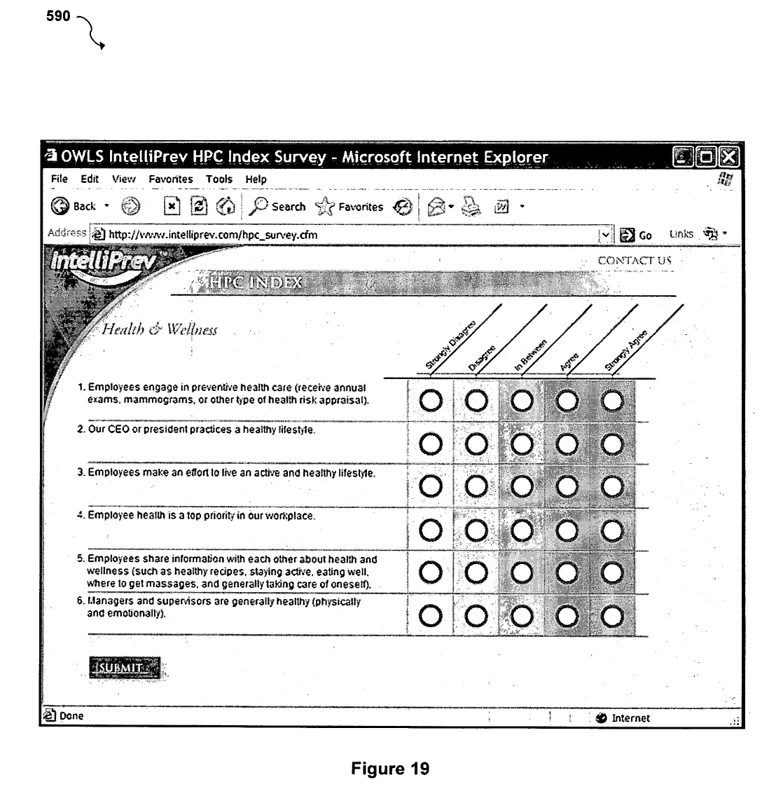

A personal HPC profile may be generated initially via a direct link to a survey. Clicking on the survey link results in the survey being displayed. This survey includes a series of statements representing perceptions and attitudes of one or more of the health and productivity categories. For example, the survey web page shown in FIG. 19 may be displayed to the user as an output following completion of the survey. Optionally, the user is automatically logged in to the system using a username and password to avoid the login process for personal HPC profile surveys.

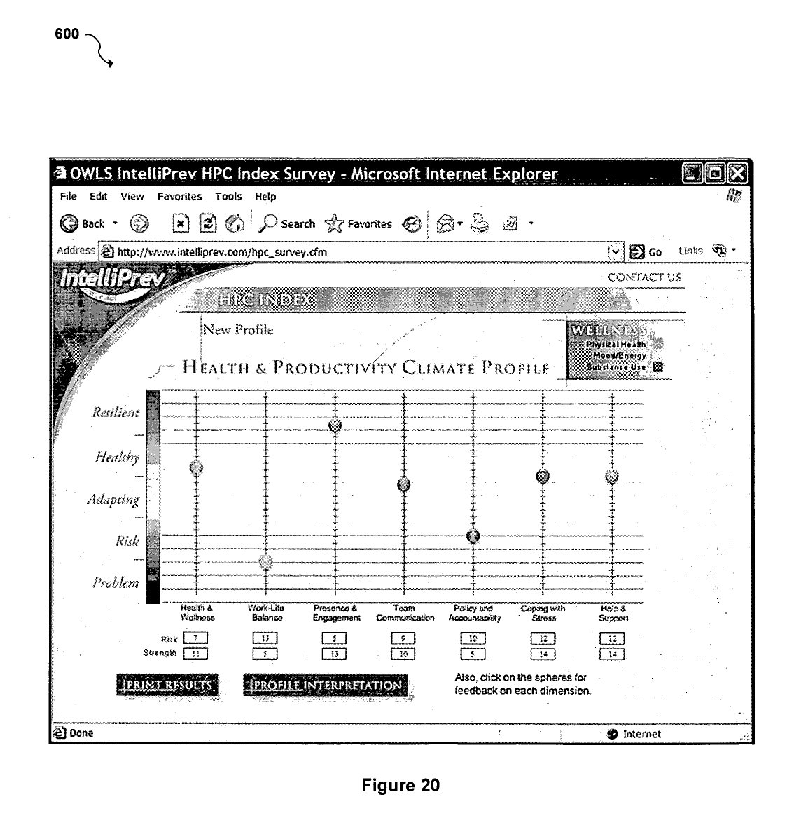

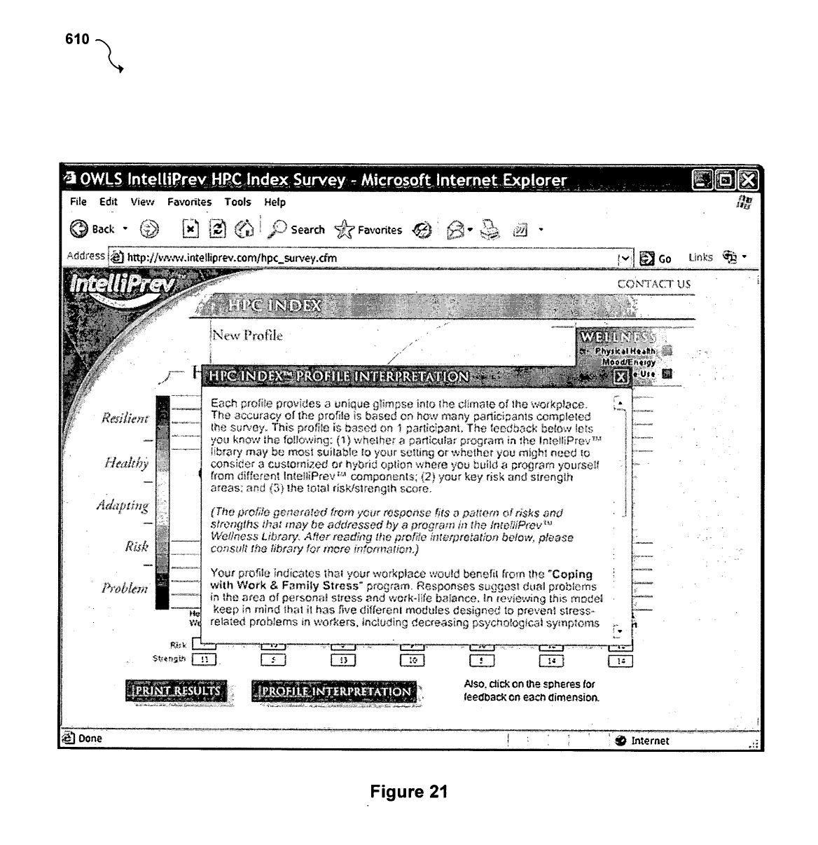

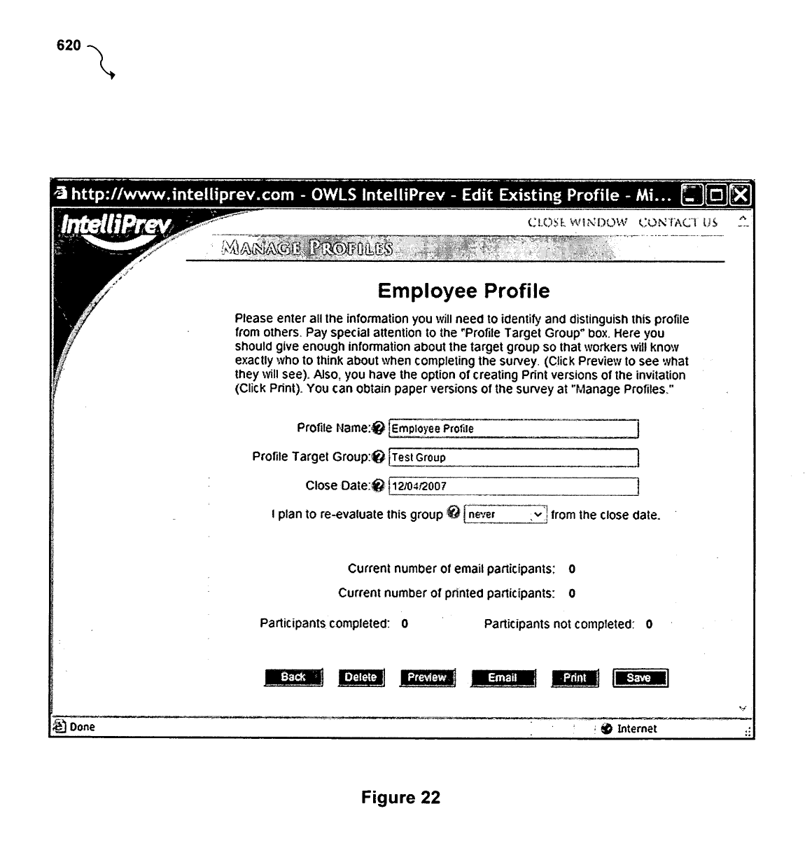

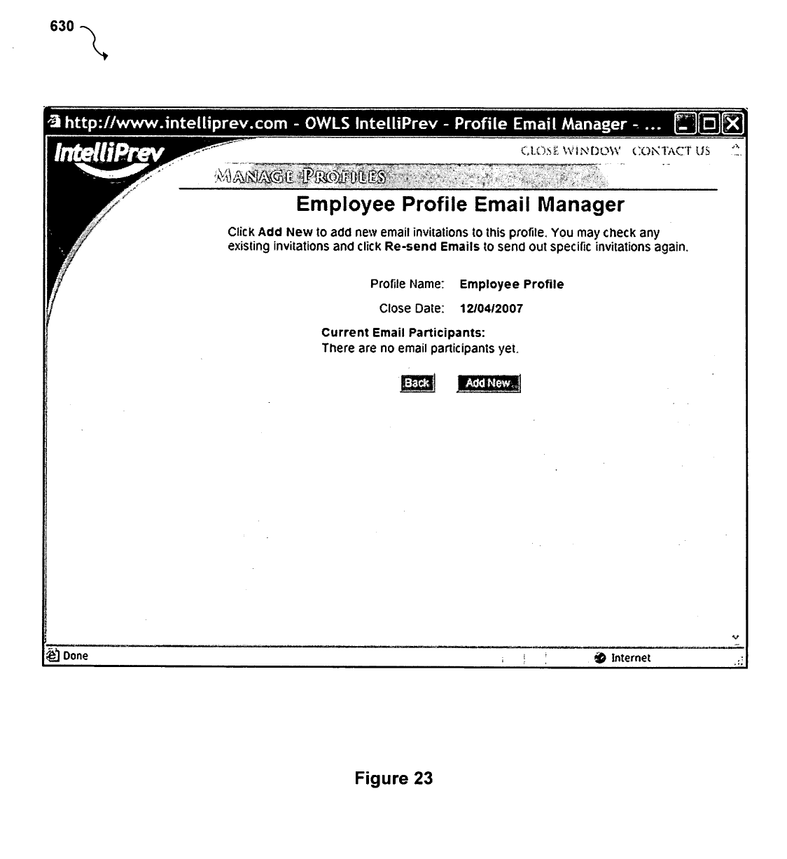

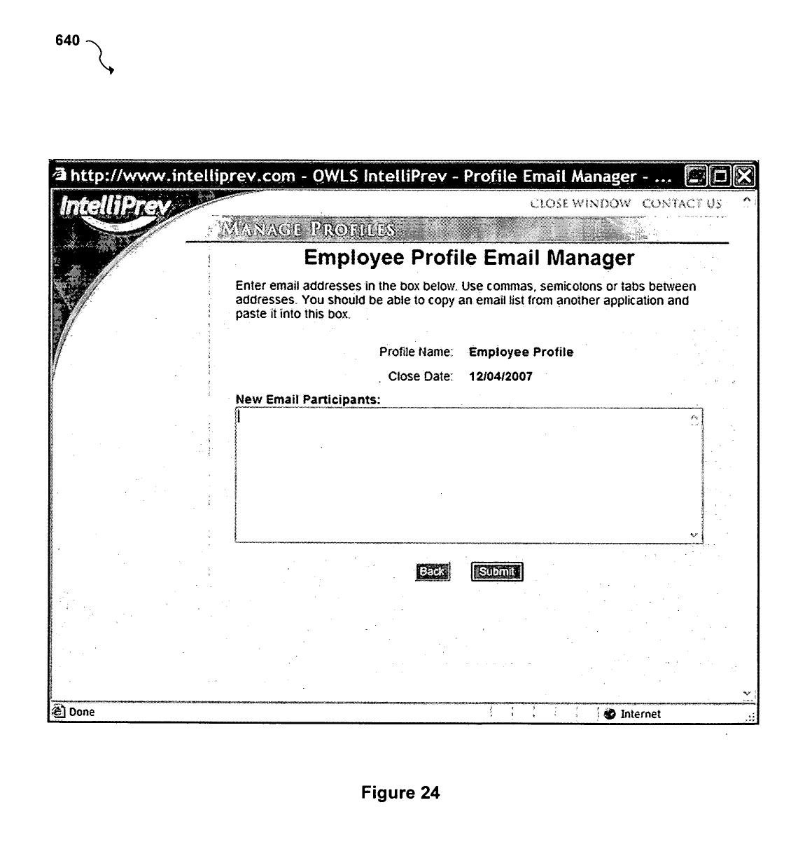

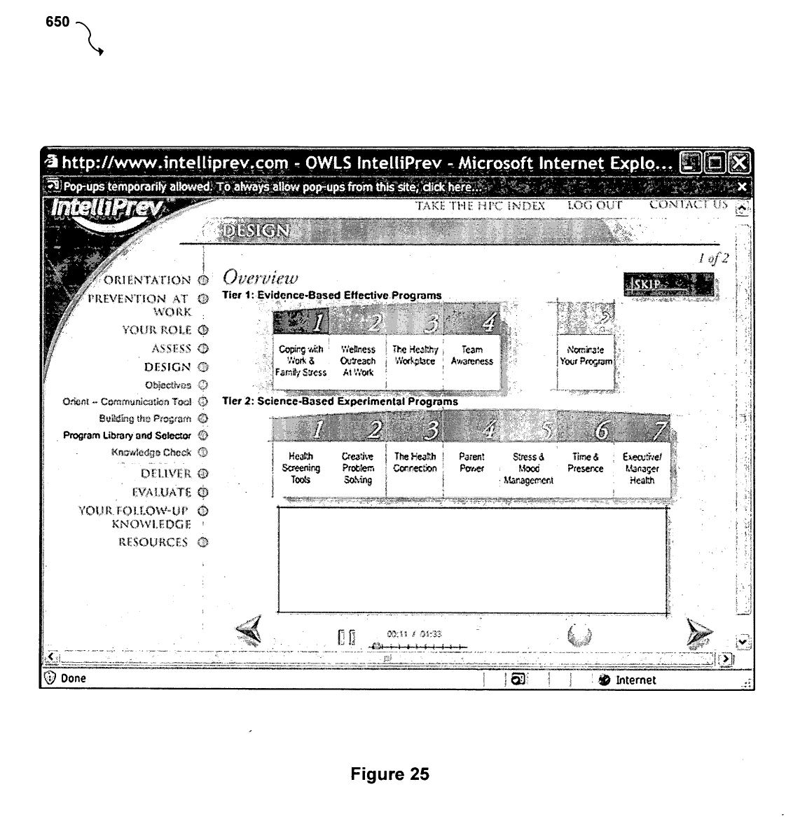

A group HPC profile may include a list of existing participants in that group. Initially, the participant list is empty. The user may add participants by providing participant information, including, without limitation, an email address of one or more participants. In one embodiment, an email notification is automatically generated and sent to the participant with the survey link and login information. Alternatively, printed notifications are generated and delivered to the participants. To protect the integrity of the system, the participants receiving the printed notifications may be required to sign consent forms to indicate that they received the information. Numerical scores, each known as an “HPC Index™,” are generated based on the results of each survey. In one embodiment, each HPC profile has a close date associated with the HPC profile. After the close date, the user can review the aggregated results of the HPC Index™ for the group. For example, results similar to those shown in FIGS. 20 and 21 may be displayed to the user. Optionally, viewing aggregated results is only allowed if a minimum number of participants have responded to the survey. For instance, nine or more participants may be required to respond to the survey before the aggregated results may be viewed.

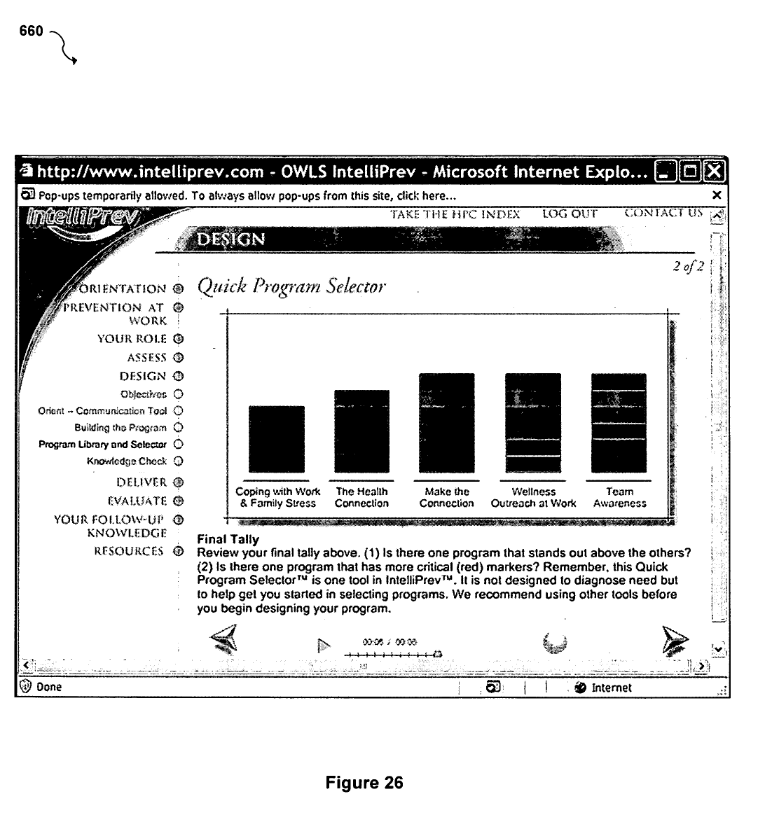

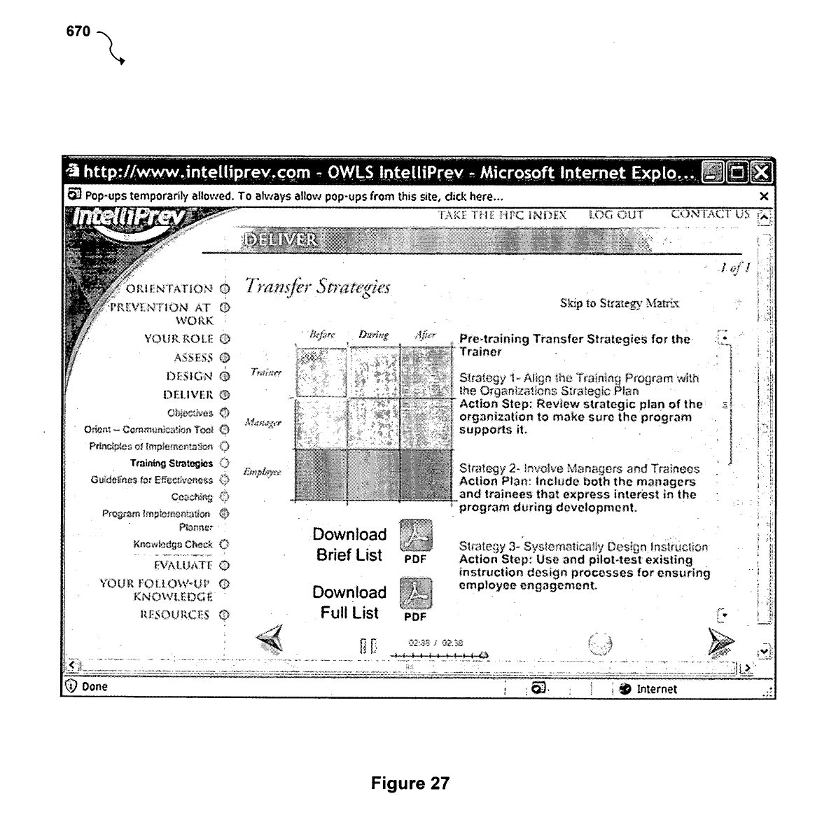

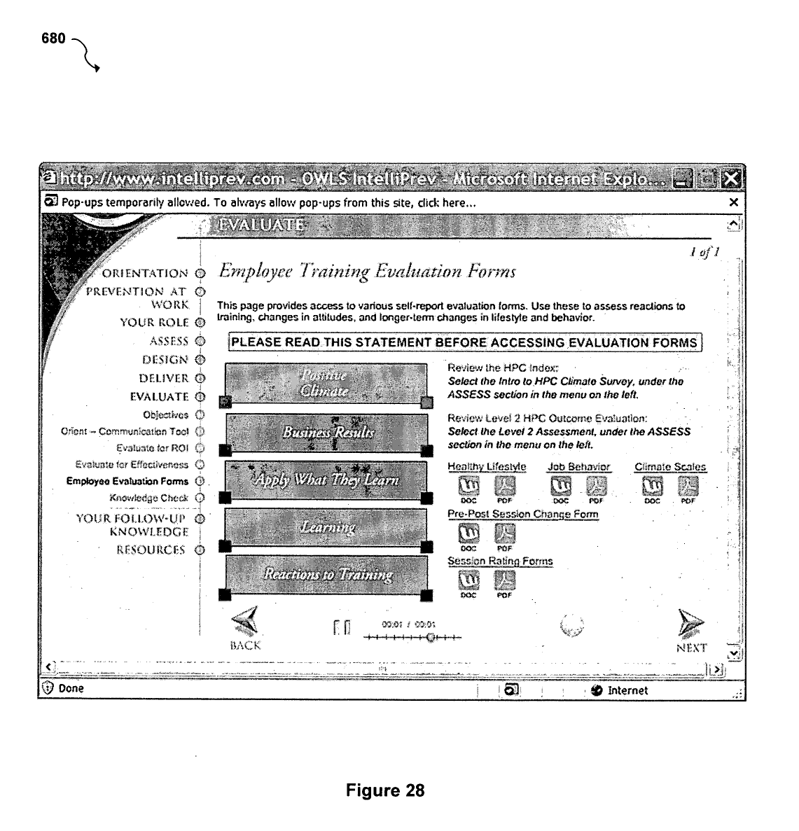

As shown at block 180, the user may design one or more programs. This step may include selecting from, and/or synthesizing from, and/or mixing or matching from, a suite of health and wellness programs designed to correct and/or improve the overall health and productivity work climate of the organization. In one embodiment, the appropriate health and wellness programs are initially automatically selected based on the results from the assessment step. Several tools are useful in designing one or more programs, including, without limitation a “Quick Program Selector” which presents the user with a series of questions to aid in the selection process. For example, the “Quick Program Selector” shown in FIG. 26 may be utilized by the user. The answers are used to determine the best resources for the delivery of the prevention training from a library of programs. It is to be understood that the design selection may either be automated based on assessment and/or design input, manual, or a combination thereof.

As shown at block 182, one or more health and wellness programs are delivered to the organization. The delivered programs are at least partially based on the design. This step includes, without limitation, the automatic delivery of selected web-based or electronic health promotion programs and/or messages to employees via the Internet or other electronic delivery means. Several tools are included within this step for optimal delivery methods designed to improve the health and productivity climate of the organization. These tools include a sub-program for selecting strategies that enhance management involvement in program delivery and a sub-program, called “Program Implementation Planner” that guides users in developing an efficient plan for scheduling program delivery.

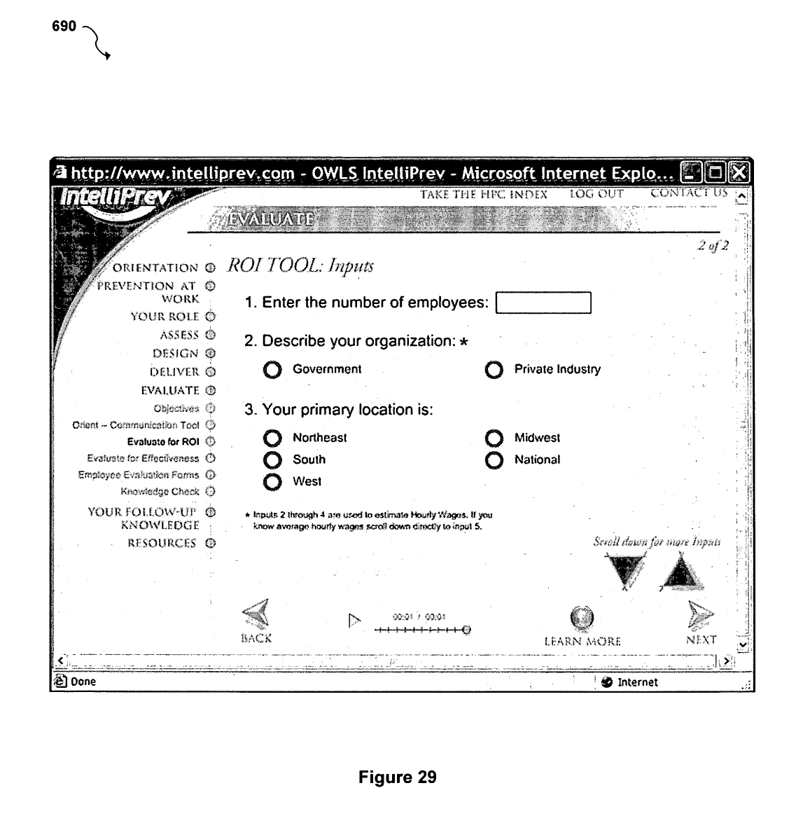

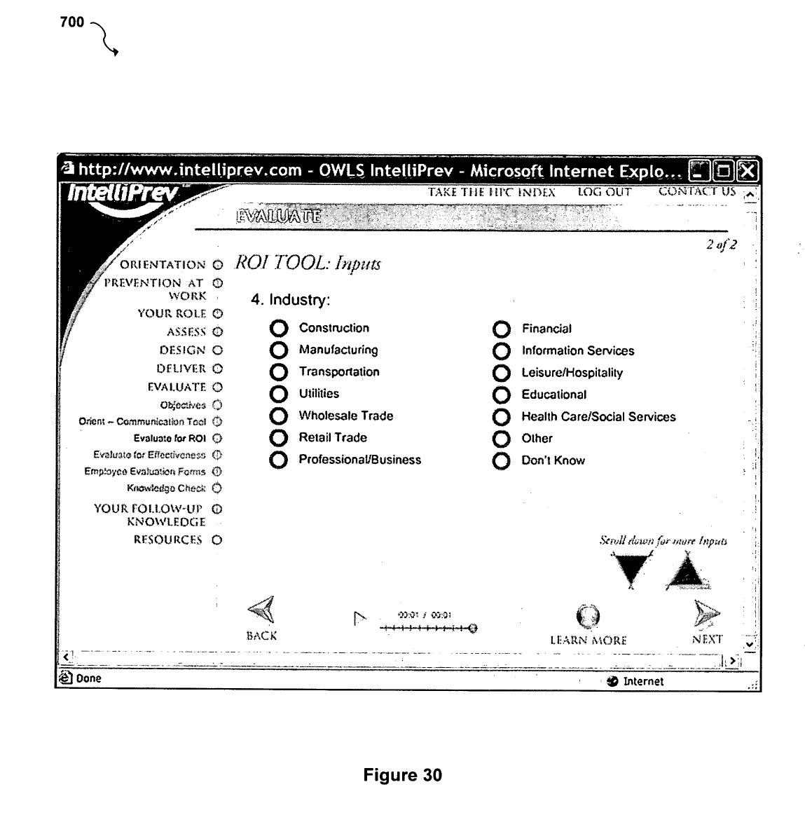

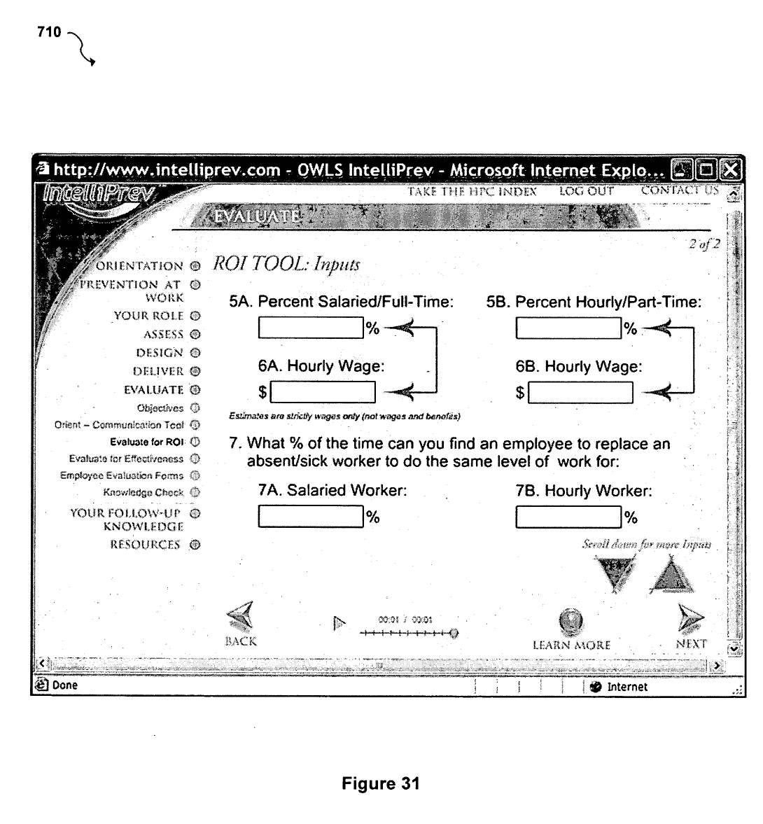

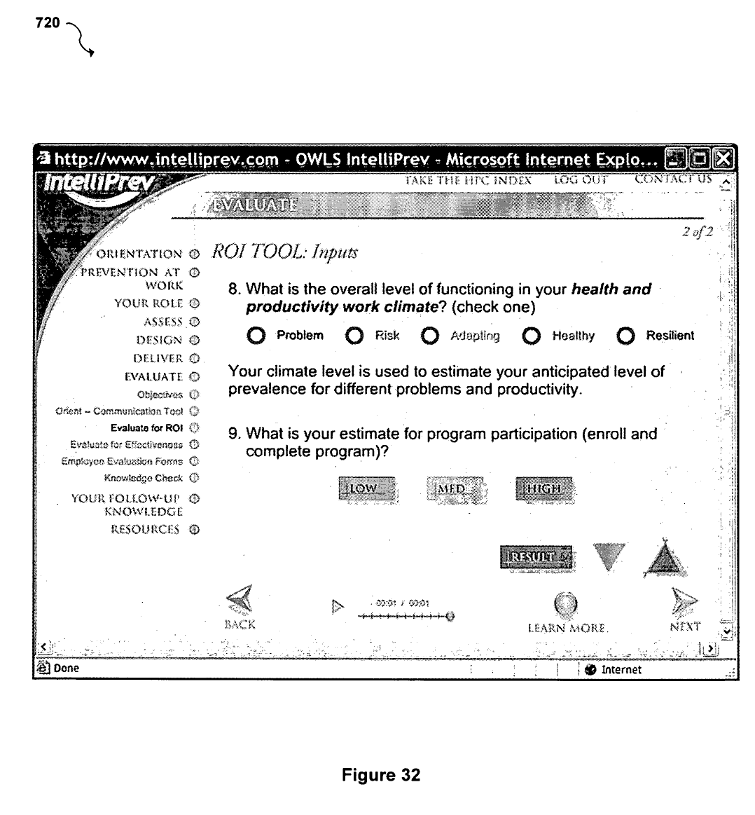

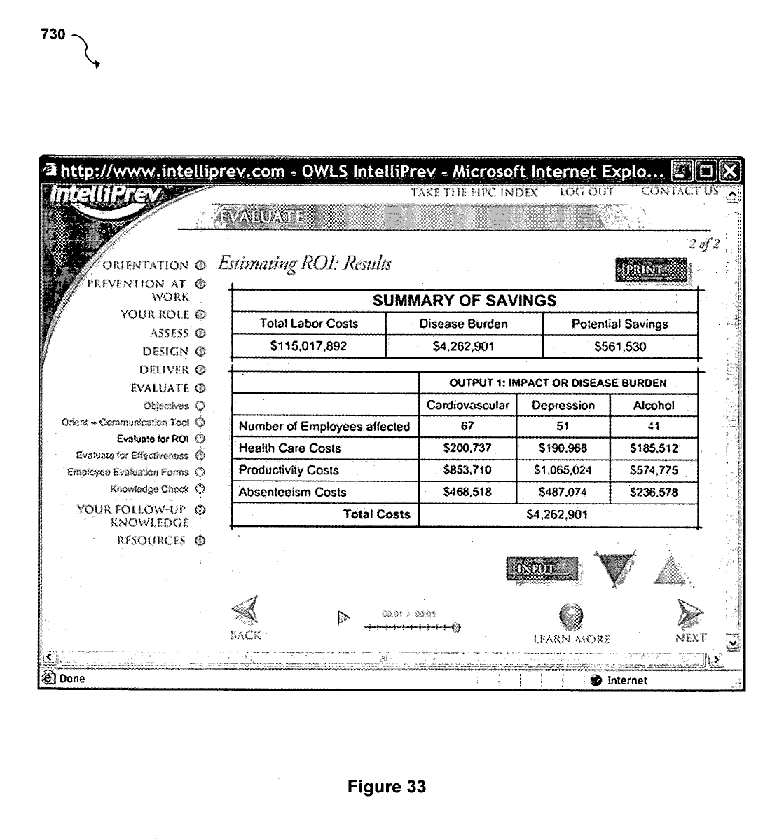

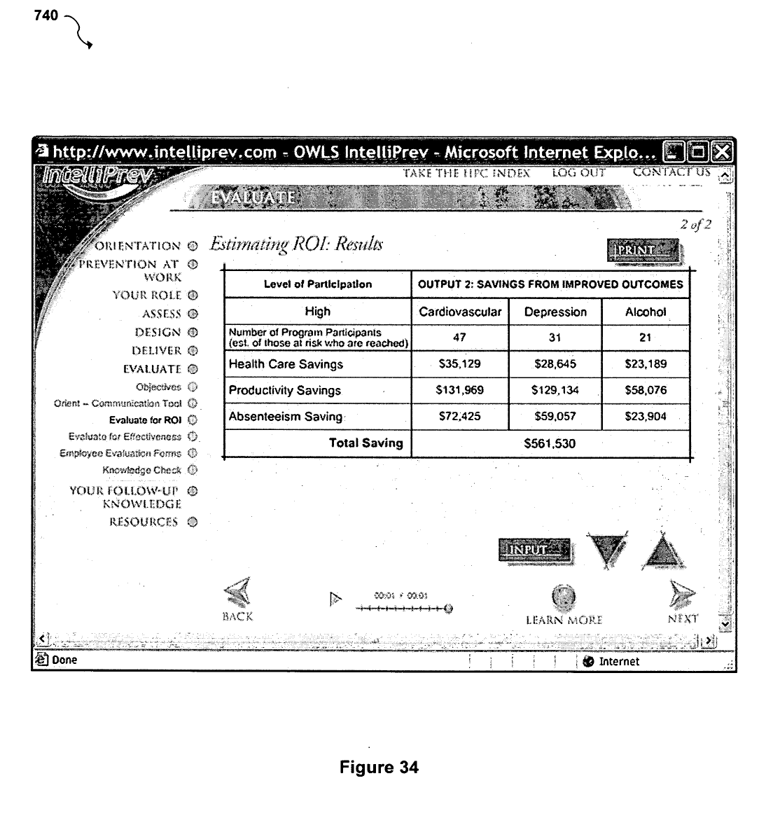

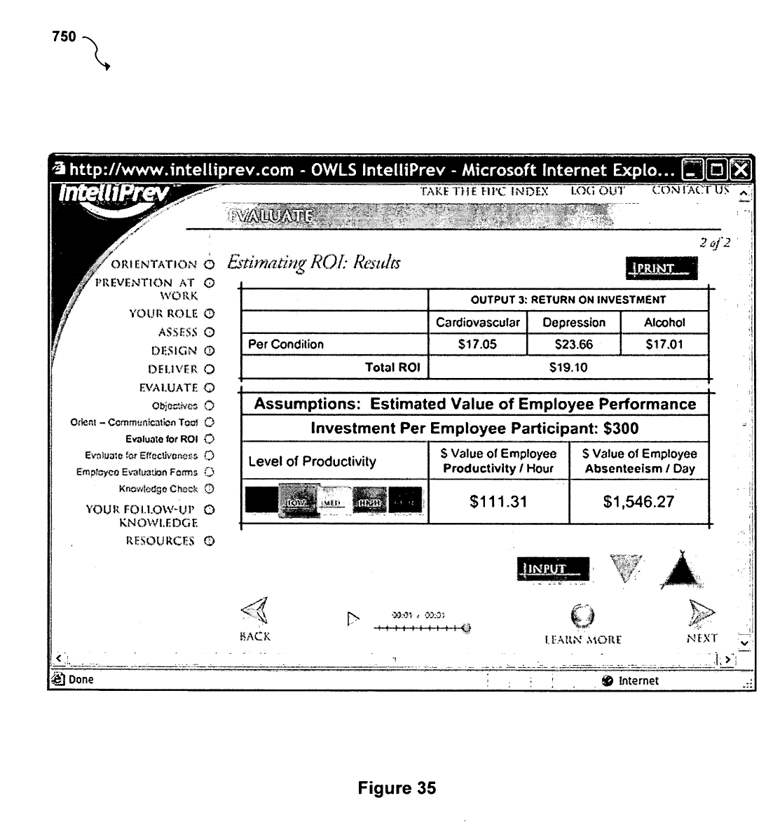

As shown at block 184, the user may choose to evaluate the effectiveness of the delivered programs. The amount of money an organization can expect to save from delivering the programs in advance of such delivery may also be computed. The effectiveness of health and wellness programs may be evaluated using any known means, including, without limitation, its financial return to the organization compared with the initial investment to deliver the programs. In one embodiment, the user utilizes the “ROI Estimator Tool” shown in FIGS. 29-35 to numerically calculate a return on investment for the organization using numerous variables, including, without limitation, the number of employees, the type of organization and regional location, the type of industry, the percentage of salaried full-time and part-time employees, the hourly wage of salaried full-time and part-time employees, the percentage of how often an absent/sick employee may be adequately replaced (the “replacement value”), the health and productivity work climate, and an estimate of program participation by the employees/members of the organization. The effectiveness of the delivered programs may also be evaluated using the results from post-delivery surveys.

The type of organization and location may be used in conjunction with data from the Bureau of Labor Statistics of the U.S. Department of Labor to estimate levels of employee compensation in terms of both wages and benefits. These estimate levels may then be used to estimate the overall productivity value of employees.

The type of industry may be used to make more accurate estimates of wages and benefits. There are significant differences in wage according to industry. In one embodiment, data from the Bureau of Labor Statistics of the U.S. Department of Labor is used to establish an national average for private industry ($24.17/hour; June 2005). This national average is then applied a weight for the particular type of industry. For example, the lowest weight is for workers in the “Leisure/Hospitality” industry (weight of 0.44), resulting in an average wage of $10.63. The highest weight is for the “Utilities” industry (weight of 1.78), resulting in an average wage of $43.02.

The percentage of salaried full-time and part-time employees, the hourly wage of salaried full-time and part-time employees, and the percentage of how often an absent/sick employee may be adequately replaced, may be used to quantify employee value in terms of both productivity and health based on the assumption that an employer pays workers in order for those workers to show up for work and be productive. The productivity of the employee is based on the employee bringing in money to the business relative to amount of money the employer is paying the employee. This is also known as the employer investment in the worker. For example, if an employer pays an employee $20/hour to produce some product (widgets or baskets), the employer is expecting that the employee will produce significantly more than $20 worth of sellable product. The impact on employee's value due to a health risk that is or could be modified through education is then compared. One consideration of this impact comparison is sickness and/or absence and the ability for the employer to replace an employee who becomes sick or absent. The “replacement value” is relevant because many modifiable health risks (like depression, problem drinking) can lead to excessive, prolonged, or erratic worker absence. Thus, knowing the replacement value of a particular worker helps to further estimate the total labor costs associated with workers. Obviously, some types of work are more easy to replace than others. For example, it is much more difficult to replace an architect or construction site coordinator in the middle of a building project than it is to replace a dishwasher or janitorial staff for a routine job. In general, higher skilled, professional, and salaried positions have greater replacement value than lower skilled, non-professional, and hourly positions.

The health and productivity work climate may be used to assess the overall level of functioning of the organization. It may be manually or automatically determined based on the assessment step as described above and shown at block 48 of FIG. 1. The health and productivity work climate may also be the estimated by the user.

The percentage of program participation measures the level of participation among employees/members of the organization in a prevention program. There are several stages to getting employees involved in wellness and prevention programs, including, without limitation: increasing awareness about programs; increasing interest and readiness; utilizing incentives; enrolling employees/members in the programs; and participation by the employees/members in the programs, and preferably, in all sessions or elements of the programs. In one embodiment, if 65% or more of the employees/members of the organization participate, then participation would be HIGH; if 30% to 50% of the employees/members of the organization participate, then participation would be MEDIUM; and if less than 30% of the employees/members of the organization participate, then participation would be LOW.

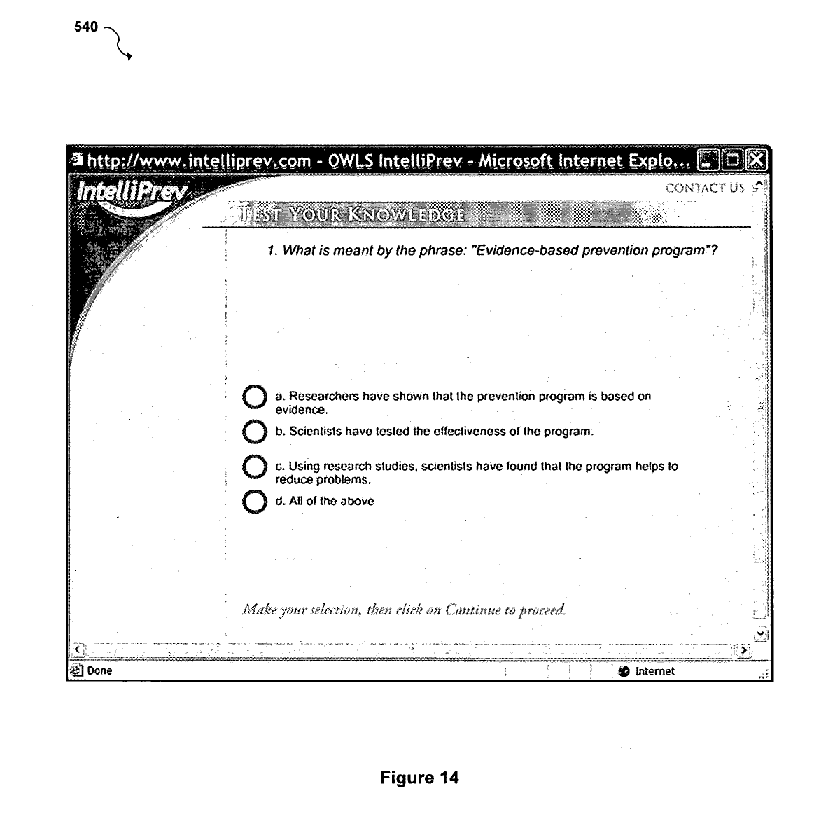

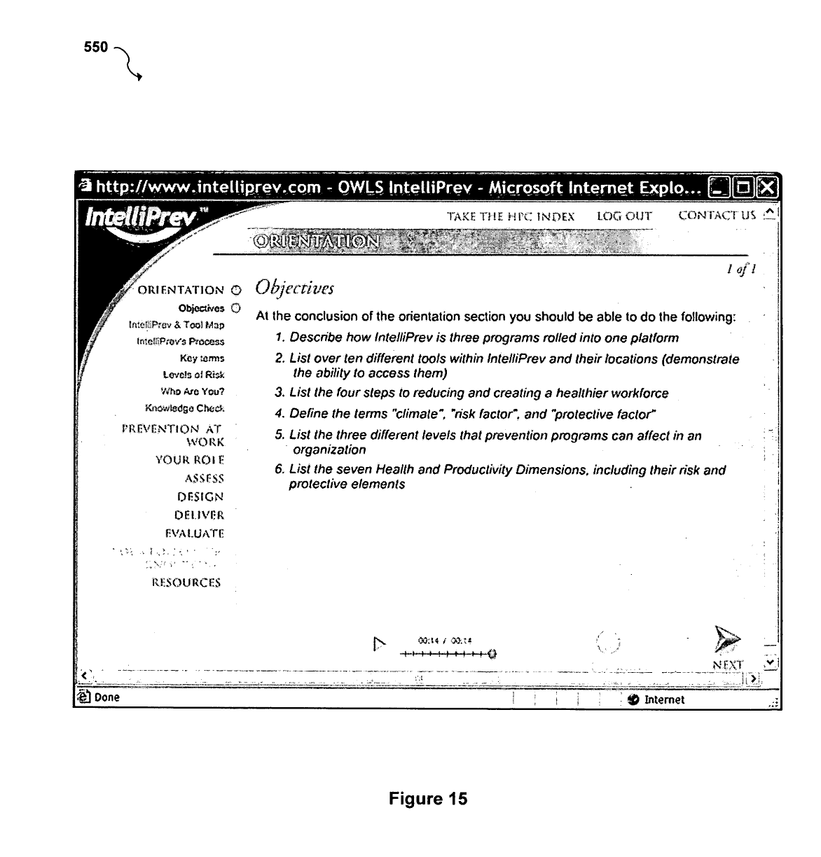

As shown at block 186, the present invention may also include e-Learning. e-learning may include, without limitation, one or more online tests configured to test the user's current knowledge. For example, the user may be presented with a series of web pages similar to those shown FIGS. 14 and 15. The online tests may be further separated into a pre-test 56 and post-test 58 such that the user's gained knowledge may be ascertained. In one embodiment, the user is required to complete the pre-test 56 before continuing. The test results may be stored in one or more databases 14. Each section of a test may be configured with a knowledge check to test the user's understanding of the material. Optionally, every knowledge check must be accessed in order to obtain access to the post-test 58. A user's progress through the material may be tracked by identifying the sections that have been previously presented to the user. Tracking information may be stored by any known means, including, without limitation, in one or more databases 14. Thereby, the user's progress may be accessed and displayed through multiple sessions. Upon completion of the knowledge checks section, the user will have access to the post-test 58. Upon completion of the post-test 58, the results may be saved in one or more databases 14. A comparison of the results from the post-test 58 results and the pre-test 56 results may then be provided to the user. Optionally, once the post-test 58 is completed, the user may use the educational module as reference material, but the user will not have access to the pre-test 56 or post-test 58. If the user terminates a session before completing the middle of the pre-test 56 or post-test 58, the test may be resumed where the user left off upon resumption. The users' answers may be stored as they are answered by any known means, including, without limitation, one or more databases 14. The pre-test 56 and post-test 58 may include one or more multiple-choice questions. However, the above description is not intended to represent all e-learning functions and other functions are possible within the scope of the present invention. For example, other e-learning functions may include sub-program self-assessment surveys for the primary contact that provide statement inputs and numerical and/or graphical outputs. These are called “Prevention Self-Efficacy™” and “Prevention Style™” questionnaires.

### Participants Module

As shown at block 212, a user initially logs in to the system. This step may include presenting the user with a form that includes a username and password, and then authenticating the entered information. As shown at block 214, the user is presented with survey designed to provide the user's individual view of the health and productivity work climate of the organization.

### Evaluating and Weighting Programs in the Intelliprev™ Library

Prior to their use in the IntelliPrev™ library, each health and wellness program is evaluated.

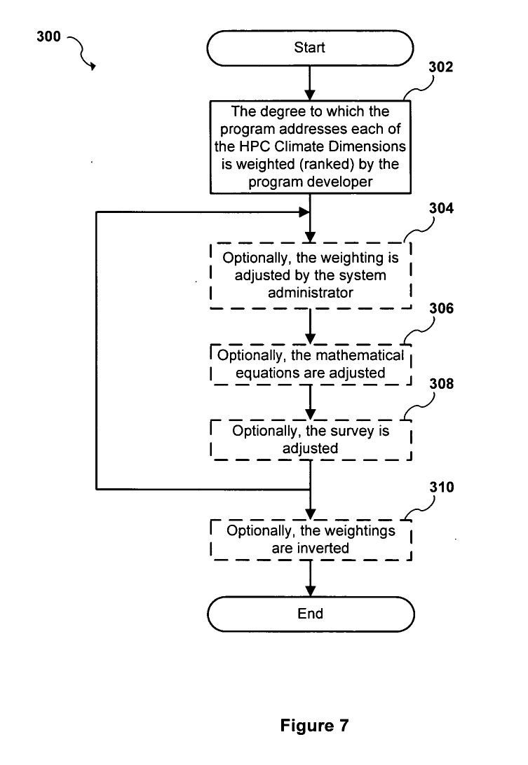

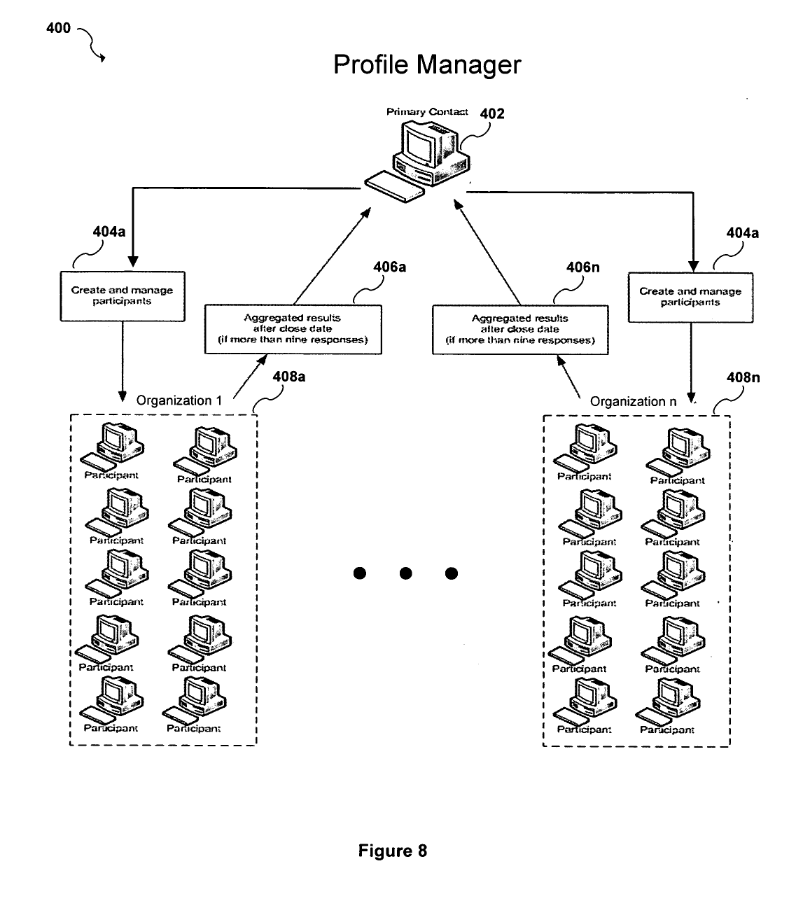

Referring to FIG. 7, a flow chart generally illustrating the system functionality with respect to assigning and adjusting weighting to discriminate between programs according to an embodiment of the present invention is shown. One or more users provide input with respect to the potential impact of the particular program on a plurality of predefined health and wellness categories, known as “HPC climate dimensions.” The number of HPC climate dimensions may obviously vary within the scope of the present invention. In one embodiment, seven HPC climate dimensions are used. Those HPC climate dimensions include, without limitation, “Health & Wellness,” “Work-Life Balance,” “Presence and Engagement,” “Team Communication,” “Policy and Accountability,” “Coping with Stress,” and “Help & Support.” The potential impact of the program on a HPC climate dimension is represented by a numerical score, known as a “weight.” In one embodiment, as shown at block 302, the developer of the health and wellness program initially provides weights in each of the HPC climate dimensions. Alternatively, the weights may initially be assigned by a system administrator without input from the program developer. The user may be provided with instructions to assist them in selecting the weightings. These weights may optionally be adjusted by a system administrator based on his/her knowledge of the program, as shown at block 304. Mathematical expressions are defined based on the weightings. The mathematical expressions may optionally be adjusted, as shown at block 306. As shown at block 308, one or more surveys may optionally be customized to ensure that they capture unique aspects of the programs being offered in the IntelliPrev™ library. The weightings, mathematical expressions, and related surveys may also be iteratively adjusted over time based on the effectiveness of the delivered programs with one or more organizations.

The weightings and the related mathematical expressions are used to numerically distinguish the health and wellness programs and to identify which programs are most appropriate to correct and/or improve the overall health and productivity work climate of the organization based on input from members of the organization. The purpose of the numerical weighting process is to identify those programs which are most appropriate to correct and/or improve certain HPC climate dimensions or, said another way, the numerical weighting process is used to identify which program is best suited for an organization based on a particular set of risk and protective circumstances as perceived and provided by members of that organization. For instance, in cases where the “Team Communication” HPC climate dimension is identified as needing correction and/or improvement (through an organization's completion of a survey), the “Team Awareness” program may be the most appropriate, whereas in cases where the “Coping with Stress” HPC climate dimension is identified as needing correction and/or improvement, the “Coping with Work & Family Stress” program may be the most appropriate.

More particularly, in one embodiment, several distinct processes are used to derive the numerical weights and scores that define the relationships between the input (HPC Index™ scale and/or item score) and the output (HPC profile interpretation or text for score-key risks and strengths areas¹). The derivation of weights is an iterative process that may be updated as new programs are added to the IntelliPrev™ library such that new items and/or HPC climate dimensions may be added to the HPC Index™ to satisfy the weightings of any particular health and wellness program. ¹Represented as spheres in FIG. 20.

Mathematical expressions are utilized to select the most appropriate health and wellness program. These algorithms are derived based on a numerical weighting process. The numerical weighting process may include the program developers initially ranking how well their particular program can correct and/or improve the overall health and productivity work climate of the organization in each of the HPC climate dimensions. Different techniques may be used to derive this ranking, including, without limitation, asking the developer to assign 100 points across the HPC climate dimensions, such that those HPC climate dimensions that best represent a need addressed by the developer's program would be given more points. For instance, if the program only addressed the “Coping with Stress” HPC climate dimension, then the developer would assign all 100 points to that HPC climate dimension.

A system administrator or operator may also examine each of the programs and assign a relative weighting and/or adjust the weighting provided by the program developers to better discriminate between the programs by means of a discriminant function, known as the “Profile to Program” function. One goal of the “Profile to Program” function is to wherever possible assign weightings such that users who receive and review the outputs (HPC profile interpretation or text for score-key risks and strengths areas) can best distinguish programs that are the best fit for the current set of needs identified by the HPC Index™. The weighting values may also be reversed, inverted and/or rescaled by the system administrator or represented as reversed, inverted and/or rescaled by the system such that the weighting values are more user-friendly and understandable to an end-user. For instance, the weighting values may be reversed such that the programs which better address a particular HPC climate dimension have a lower numerical value (rather than the highest numerical value). It is possible that two health and wellness programs will both address a highly similar set of risks. In this instance, the outputs (HPC profile matches and key risks and strengths) may be adjusted to assist the end-user in making fine comparisons.

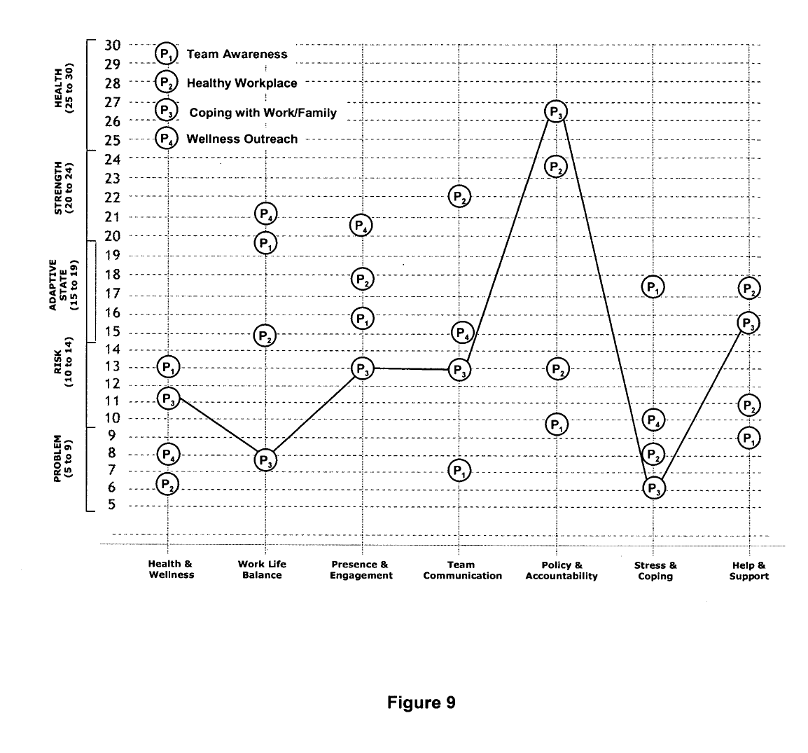

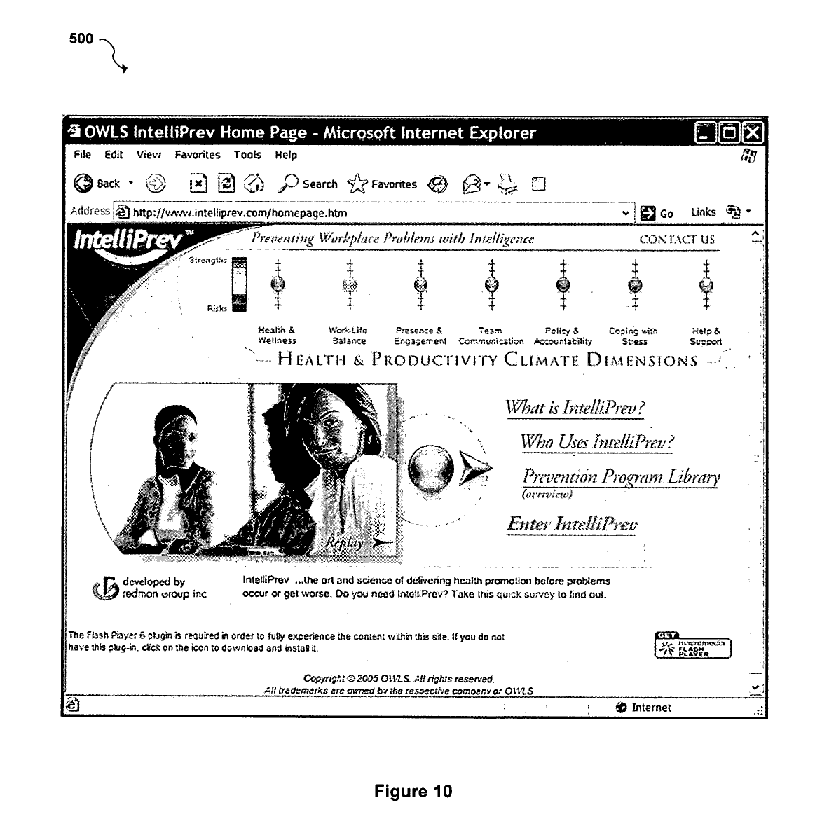

Referring to FIG. 9, a chart depicting exemplary weightings associated with several health and wellness programs (P₁, P₂, P₃ and P₃) in each of the HPC climate dimensions according to an embodiment of the present invention is shown. In this example, the weightings vary from 6 to 30. The degree to which the program addresses a particular HPC climate dimension is represented by the weighting; the program best addressing the HPC climate dimension having the lowest weight. For instance, the program (P₂) best addresses the “Health & Wellness” HPC climate dimension because it has the lowest numerical value. Additionally, each of the programs (P₁, P₂, P₃ and P₄) appear to address the “Health & Wellness” HPC climate dimension. In contrast, the program (P₁) (and to a lesser extent the program (P₂)) appears to address the “Policy & Accountability” HPC climate dimension, whereas the two other programs (P₃ and P₄) do not appear to be designed to address this HPC climate dimension. Because all of the programs (P₁, P₂, P₃ and P₄) appear to address the “Health & Wellness” HPC climate dimension, more computations may be required to distinguish these programs (P₁, P₂, P₃ and P₄) on the “Health & Wellness” HPC climate dimension than on the “Policy & Accountability” HPC climate dimension. These computations may include various item and subscale scores. For example, the program (P₄) may be more likely to address the “Physical Health” subscale elements of the “Health & Wellness” HPC climate dimension, whereas the program (P₃) may be more likely to address the “Mood & Energy” subscale elements of the “Health & Wellness” HPC climate dimension. FIG. 20 displays one example of output representations of this profile score.

The IntelliPrev™ library and the HPC Index™ are subject to continual updating and iterative modifications as new health and wellness programs are considered for placement in the IntelliPrev™ library and in keeping with existing weights and discriminant function as described above. It is possible that programs may require changing or adding HPC items or HPC climate dimensions in the future. In other words, the current configuration of the IntelliPrev™ library and diagnostic tool are meant to be a current but not only embodiment of the present invention.

### Selecting the Most Appropriate Programs

One or more of a set of statements within the HPC Index are used to select the most appropriate health and wellness programs to correct and/or improve the overall health and productivity work climate of the organization based on input from members of the organization. The “most appropriate” programs are those deemed to be most likely to be effective in improving the work climate and/or one or more member's perceptions of the work climate on one or more categories within the HPC Index. Specifically, an algorithm, utilizing a set of one or more statements from the HPC Index and the predefined mathematical expressions, recommends and/or selects the most appropriate health and wellness programs to correct and/or improve the overall health and productivity work climate of the organization. Thus, any program within the IntelliPrev™ library may be said to have an “effectiveness score” which specifically means that the program receives a numerical weight on one or more of the HPC categories such that when users provide numerical inputs to that category, and those inputs meet a pre-defined value, then the algorithm indicates that the particular program may be selected as addressing the need represented by the score within one or more of the HPC categories. Various HPC profile outputs are used in making the selection and/or recommendation. In addition, an HPC profile of an organization, including one or more scores, across each of the HPC climate dimensions may be displayed. These scores fall into one of several levels of “risk.” In one embodiment, five levels of “risk” are used. These levels of “risk” include, without limitation, “Resilient,” “Healthy,” “Adapting,” “Risk,” and “Problem,” as described below:
Resilient: The health and productivity work climate of the organization is very healthy to the point where the organization can take on new challenges and periods of growth or decline without concern. Overall, the employees/members of the organization are much healthier and proactive about their health than the average organization.
Healthy: The health and productivity work climate of the organization is healthy. Employees/members feel that their health and safety is a top priority. Overall, the employees/members of the organization are somewhat healthier than the average organization.
Adapting: The health and productivity work climate of the organization is neither very healthy nor very sick for any period of time. The employees/members of the organization feel that they are more or less getting by and everyone is functioning “normally” in terms of their health and well-being.
Risk: The health and productivity work climate of the organization is presently experiencing some risks that must get addressed. There are a number of employees/members of the organization who are functioning below “normal” productivity or are engaging in health and safety risks that can become problematic.
Problem: The health and productivity work climate of the organization has been experiencing explicit problems for a period of time and employees/members of the organization either complain or are concerned about their health and well-being or they show very little interest in improving.

Another example for interpreting the effectiveness score of a program is any score that implies that, should the program be delivered to the organization, it will have the effect of improving the work climate from any one level to at least the subsequent level as such: from “Problem” to “Risk,” from “Risk” to “Adapting,” from “Adapting” to “Healthy” and from “Healthy” to “Resilient.” However, it is to be understood that any number of levels having any name identifier or numeric range may be used within the scope of the present invention. It is further to be understood that the use of levels of “risk” is not required within the scope of the present invention. For instance, the HPC climate dimensions may simply have an associated numerical value without utilizing a level of “risk.”

### Example Survey

The following example is provided to demonstrate implementation of a survey. It is to be understood that the number of programs and their associated weightings and mathematical expressions, and the number HPC climate dimensions, are provided below for exemplary purposes and may be varied without departing from the scope of the invention. It is also to be understood that the dimensions represent current embodiments and may also refer in future embodiments to actual health care risk data—as is collected through health risk appraisals. For exemplary purposes, the HPC climate dimensions “Health & Wellness,” “Work-Life Balance,” “Presence & Engagement,” “Team Communication,” “Policy and Accountability,” “Coping with Stress” and “Help & Support” are respectively identified in this example with the variables W, B, P, T, A, C and S:

Health & Wellness (W)

Work-Life Balance (B)

Presence & Engagement (P)

Team Communication (T)

Policy and Accountability (A)

Coping with Stress (C)

Help & Support (S)

For instance, as shown above, the HPC climate dimension “Health & Wellness” is identified with the variable (W) and the HPC climate dimension “Coping with Stress” is identified with the variable (C).

As an example, for demonstrating scoring purposes within the “Health & Wellness” dimension, the risk items are reverse scored. As such, lower scores indicate greater risks and higher scores indicate lower risks (greater strengths). Using a reverse scale, “1” indicates “not a problem” and “5” indicates “a great problem.”

Strength items are scored as follows:

1=Strongly Disagree

2=Disagree

3=In Between

4=Agree

5=Strongly Agree

Risk items are scored as follows:

1=Not a Problem at all

2=A little bit of a Problem

3=Somewhat of a Problem

4=A Definite Problem

5=A Great Problem

Each scale is scored from a range of 6 to 30, with higher scores indicating more positive (strengths) ratings. Thus, each HPC climate dimension should be treated as a single HPC climate dimension. There are two components to each HPC climate dimension: risks and strengths. Risks are reverse scored. Subscale strength and risk scores are provided for these HPC climate dimensions. Also, note that the “Health & Wellness” HPC climate dimension has a different scoring key.

| SCALE (CODE) | | STRENGTH ITEMS | RISK ITEMS² |
|---|---|---|---|
| Health & Wellness (W) | | 6 | 11 |
| | SUBSCALES | | |
| | Physical | | 4 |
| | Mood/Energy | | 3 |
| | Substance Use | | 4 |

| | | |
|---|---|---|
| Work-Life Balance (B) | 3 | 3 |
| Presence & Engagement (P) | 3 | 3 |
| Team Communication (T) | 3 | 3 |
| Policy and Accountability (A) | 3 | 3 |
| Coping with Stress (C) | 3 | 3 |
| Help & Support (S) | 3 | 3 |
| TOTAL | 24 | 39 |

Five levels of strength are represented with respect to the HPC climate dimensions:
(1) Problem (a score ranging from 6 to 10)
(2) Risk (a score ranging from 11 to 15)
(3) Adaptive State (a score ranging from 16 to 20)
(4) Strength (a score ranging from 21 to 25)
(5) Resiliency (a score ranging from 26 to 30)

### A. Health & Wellness HPC Climate Dimension

The Health & Wellness HPC climate dimension examines risk and strength health behaviors among employees in different areas of health (physical, emotional, social).

Health & Wellness (W) strength items 1 through 6 (responses are Ws₁ to Ws₆):
(1) Employees engage in preventive health care (receive annual exams, mammograms, or other type of health risk appraisal).
(2) Our CEO or president practices a healthy lifestyle.
(3) Employees make an effort to live an active and healthy lifestyle.
(4) Employee health is a top priority in our workplace.
(5) Employees share information with each other about health and wellness (such as healthy recipes, staying active, eating well, where to get massages, and generally taking care of oneself).
(6) Managers and supervisors are generally healthy (physically and emotionally). ²Risk items are reverse scored.

Health & Wellness (W) risk items 1 through 11 (responses are Wr₁ to Wr₁):
(1) Employees show signs of being overweight.
(2) Employees do not have healthy eating practices (for example, too many high fat foods, sugar, caffeine, and not enough fruits and vegetables).
(3) Employees fail to get active, aerobic exercise on a regular basis (for example, jogging, bicycling, aerobics classes, swimming, team sports, etc.)
(4) Employees are not otherwise active in their daily lifestyle (for example, gardening, household chores, walking).
(5) Employees complain that they do not sleep well or often tired, fatigued, or exhausted.
(6) Employees show signs of depression (appear sad, show poor concentration, have unhappy “body language”).
(7) Employees show signs of anxiety (are insecure, worried, jittery, nervous, fearful).
(8) Employees use tobacco or nicotine (including cigarettes, snuff, cigars, pipe tobacco).
(9) Employees misuse alcohol (beer, wine, or liquor), or drink more than is safe, or show signs of needing (being dependent upon) alcohol.
(10) Employees work under the influence of alcohol, or work with a hangover, or miss work due to a hangover.
(11) Employees misuse prescription or over-the-counter drugs, or use in ways that negatively effect their ability to work effectively.

The “Health & Wellness” HPC climate dimension includes several subscales, including, without limitation “Wellness-Physical,” “Wellness-Mood/Energy” and “Wellness-Substance Use” which are respectively identified in this example with the variables W_P, W_ME and W_SU:

Wellness-Physical (W_P)

Wellness-Mood/Energy (W_ME)

Wellness-Substance Use (W_SU)

The Health & Wellness (W) HPC climate dimension is scored as follows:
STEP 1: Calculate the Health & Wellness (W) strength score as the average of the Health & Wellness (W) strength items:

$$Ws = {\sum }_{n ∈ 1 …6} ( {Ws}_{n} ) / 6 where Ws ranges from 1 to 5$$

STEP 2: For each of the risk subscale components (Wellness-Physical (W_P), Wellness-Mood/Energy (W_ME) and Wellness-Substance Use (W_SU) subscale scores), calculate the subscale risk score as the average of the respective Health & Wellness (W) respective subscale risk items:

$$\begin{matrix} W\_P = {\sum }_{n ∈ 1 …4} {Wr}_{n} / 4 & W\_P ranges from 1 to 5 \\ W\_ME = {\sum }_{n ∈ 5 …7} {Wr}_{n} / 3 & W\_ME ranges from 1 to 5 \\ W\_SU = {\sum }_{n ∈ 8 …11} {Wr}_{n} / 4 & W\_SU ranges from 1 to 5\end{matrix}$$

STEP 3: Calculate the final Health & Wellness (W) HPC climate dimension score as follows:

| | |
|---|---|
| OUT₁ = Ws + [(W_P + W_ME + W_SU)/2] | OUT1 ranges from 1 |
| | to 5 |
| SCORE = OUT₁ * 6 | SCORE ranges from |
| | 6 to 30 |

### B. Work-Life Balance HPC Climate Dimension

The Work-Life Balance HPC climate dimension examines the employees' ability to balance work and personal or family areas of their lives.

Work-Life Balance (B) strength items 1 through 3 (responses are Bs₁ to Bs₃):
(1) Managers and supervisors are sensitive to the family and personal concerns of employees.
(2) Employees feel comfortable talking about their family needs with supervisors and coworkers.
(3) Employees are able to balance the demands of work and family without much difficulty.

Work-Life Balance (B) risk items 1 through 3 (responses are Br₁ to Br₃):
(1) Employee work demands interfere with their having a good home and personal life.
(2) People have difficulties and problems at home that negatively impact their work effectively.
(3) Employees need more knowledge about how to effectively balance work, personal, and family demands.

The Work-Life Balance (B) HPC climate dimension is scored as follows:
STEP 1: Reverse score Br₁ to Br₃ such that lower scores indicate greater risk.
STEP 2: Calculate the sum of all Work-Life Balance (B) scores:

$$B = {\sum }_{n ∈ 1 …3} ( {Bs}_{n} ) + {\sum }_{n ∈ 1 …3} ( {Br}_{n} ) where B ranges from 6 to 30$$

C. Presence & Engagement HPC climate dimension

The Presence & Engagement HPC climate dimension examines different aspects of the employees' involvement at work, including absences, lateness, being present at work, and work commitment.

Presence & Engagement (P) strength items 1 through 3 (responses are Ps₁ to Ps₃):
(1) Managers and supervisors inspire employees to do high quality work.
(2) Employees and their coworkers are involved at work and committed to doing a good job.
(3) People consider the work they do to be meaningful and important.

Presence & Engagement (P) risk items 1 through 3 (responses are Pr₁ to Pr₃):
(1) Absenteeism and/or lateness are a real problem in this workplace.
(2) Workers show signs of being withdrawn at work. That is, they are present physically, but they do not fully ‘show up’ mentally.
(3) Employee personal health problems interfere with their being fully engaged at work.

The Presence & Engagement (P) HPC climate dimension is scored as follows:
STEP 1: Reverse score Pr₁ to Pr₃ such that lower scores indicate greater risk.
STEP 2: Calculate the sum of all Team Communication (P) scores:

$$P = {\sum }_{n ∈ 1 …3} ( {Ps}_{n} ) + {\sum }_{n ∈ 1 …3} ( {Pr}_{n} ) where P ranges from 6 to 30$$

### D. Team Communication HPC Climate Dimension

The Team Communication HPC climate dimension examines the level of communication and support between employees in the workplace.

Team Communication (T) strength items 1 through 3 (responses are Ts₁ to Ts₃):
(1) People work together well as a team.
(2) We know how to communicate with each other to solve problems that arise.
(3) Coworkers are willing to work together to help solve problems that come up at work.

Team Communication (T) risk items 1 through 3 (responses are Tr₁ to Tr₃):
(1) Conflicts between coworkers are avoided or “swept under the rug” rather than addressed more directly.
(2) I know angry (alienated, irritated) coworkers who do not feel listened to by others at work.
(3) Managers and supervisors rarely listen to employees' ideas and suggestions.

The Team Communication (T) HPC climate dimension is scored as follows:
STEP 1: Reverse score Tr₁ to Tr₃ such that lower scores indicate greater risk.
STEP 2: Calculate the sum of all Team Communication (T) scores:

$$T = {\sum }_{n ∈ 1 …3} ( {Ts}_{n} ) + {\sum }_{n ∈ 1 …3} ( {Tr}_{n} ) where T ranges from 6 to 30$$

### E. Policy and Accountability HPC Climate Dimension

The Policy and Accountability HPC climate dimension examines accountability for health and safety behavior at work.

Policy and Accountability (A) strength items 1 through 3 (responses are As₁ to As₃):
(1) Coworkers are respectful of workplace policies (including smoke free workplace, safety rules, drug free workplace, and sexual harassment).
(2) The work environment supports employee efforts to live an active and healthy lifestyle (such as fitness activities and/or facilities, time for breaks and stretches, healthy food in vending machines, sports teams for workers).
(3) Managers are more likely to address than to neglect problem situations and problem employees (who are angry, depressed, or have alcohol problems).

Policy and Accountability (A) risk items 1 through 3 (responses are Ar₁ to Ar₃):
(1) If a coworker was under the influence of alcohol or drugs at work, employees would likely do nothing about it or they would ‘pick up the slack’ for the coworker.
(2) Supervisors and/or coworkers are careless about safety rules and regulations.
(3) Policies and procedures in our workplace are ineffective.

The Policy and Accountability (A) HPC climate dimension is scored as follows:
STEP 1: Reverse score Ar₁ to Ar₃ such that lower scores indicate greater risk.
STEP 2: Calculate the sum of all Policy and Accountability (A) scores:

$$A = {\sum }_{n ∈ 1 …3} ( {As}_{n} ) + {\sum }_{n ∈ 1 …3} ( {Ar}_{n} ) where A ranges from 6 to 30$$

F. Coping with Stress HPC Climate Dimension

The Coping with Stress HPC climate dimension examines the employees' stress levels, and whether workers have skills they need to deal with stress.

Coping with Stress (C) strength items 1 through 3 (responses are Cs₁ to Cs₃):
(1) Workers recognize when their personal stress levels get too high and cope well before stress hurts their performance.
(2) Managers understand the level of job stress and strain employees face and make an effort to reduce rather than add to their stress.
(3) Employees have the skills and knowledge to address different types of stress that come up at work (such as deadlines, heavy work loads, conflicts, and times of uncertainty).

Coping with Stress (C) risk items 1 through 3 (responses are Cr₁ to Cr₃):
(1) Employees are constantly under heavy pressure in their jobs.
(2) Employees have had difficulty due to recent stressful events in their lives (such as accident, divorce, loss or death, financial problems, or family/relationship problems).
(3) Employees need more skills and knowledge on how to recognize and cope with stress in their personal lives.

The Coping with Stress (C) HPC climate dimension is scored as follows:
STEP 1: Reverse score Cr₁ to Cr₃ such that lower scores indicate greater risk.
STEP 2: Calculate the sum of all Coping with Stress (C) scores:

$$C = {\sum }_{n ∈ 1 …3} ( {Cs}_{n} ) + {\sum }_{n ∈ 1 …3} ( {Cr}_{n} ) where C ranges from 6 to 30$$

### G. Help & Support HPC Climate Dimension

The Help & Support HPC climate dimension examines employee help-seeking for personal problems. This includes benefits and manager support for getting help.

Help & Support (S) strength items 1 through 3 (responses are Ss₁ to Ss₃):
(1) Our workplace provides access to and promotes resources for employee mental health, alcohol, and drug abuse problems (such as an employee assistance program or EAP).
(2) Managers and supervisors are understanding and show concern for employees who are going through a hard time.
(3) Employees have friends and family outside of work they can rely on for support in times of need.

Help & Support (S) risk items 1 through 3 (responses are Sr₁ to Sr₃):
(1) Employees need more skills and information about how to access services (such as an employee assistance program or EAP) for personal and family problems.
(2) Employees with personal problems do not seek help (such as counseling) because they are afraid of being labeled or judged by coworkers.
(3) Managers and supervisors do not encourage poorly performing workers to get help.

The Help & Support (S) HPC climate dimension is scored as follows:
STEP 1: Reverse score Sr₁ to Sr₃ such that lower scores indicate greater risk.
STEP 2: Calculate the sum of all Help & Support (S) scores:

$$S = {\sum }_{n ∈ 1 …3} ( {Ss}_{n} ) + {\sum }_{n ∈ 1 …3} ( {Sr}_{n} ) where S ranges from 6 to 30$$

### Example Profile Matching

The following example is provided to demonstrate profile matching and use of weighting variables and the related mathematical expressions. A “Profile Match” is one example of how inputs from the HPC Index™ survey are compiled into a formula whereby users receive an output indicating which program or set of programs within the IntelliPrev™ library are to be considered for implementation. More specifically, a profile match refers to a set of HPC Index™ survey inputs that, taken together formulaically, discriminate, or uniquely match up with the goals and objectives of specific programs within the IntelliPrev™ library. Said another way, a formula is designed for the purpose of indicating one or more of the health and wellness programs that are best indicated to address the implied needs as represented by the configuration of a subset of HPC statements as represented in the formula. It is to be understood that the number of programs and their associated weightings and mathematical expressions, and the number of HPC climate dimensions, are provided below for exemplary purposes and may be varied without departing from the scope of the invention.

For purposes of profile matching, the Wellness-Physical (W_P), Wellness-Mood/Energy (W_ME) and Wellness-Substance Use (W_SU) subscale scores are each summed rather than being averaged using the following formulas:

$$\begin{matrix} W\_P = {\sum }_{n ∈ 1 …4} ( {Wr}_{n} ) & with scores ranging from 4 to 20 \\ W\_ME = {\sum }_{n ∈ 5 …7} ( {Wr}_{n} ) & with scores ranging from 3 to 15 \\ W\_SU = {\sum }_{n ∈ 8 …11} ( {Wr}_{n} ) & with scores ranging from 4 to 20\end{matrix}$$

As shown above, for purposes of profile matching: the Wellness-Physical (W_P) subscale score is the sum of the Health & Wellness (W) responses 1 through 4; the Wellness-Mood/Energy (W_ME) subscale score is the sum of the Health & Wellness (W) responses 5 through 7; and the Wellness-Substance Use (W_SU) subscale score is the sum of the Health & Wellness (W) responses 8 through 11. However, these subscale scores are averaged for the special significator on the profile feedback interface (not shown). The Health & Wellness-Substance Use (W_SU) subscale includes several responses, including, without limitation “Wellness-Substance Use-Alcohol Misuse,” “Wellness-Substance Use-Work Related Alcohol” and “Wellness-Substance Use-Prescription Misuse” which are respectively identified in this example with the variables W_SU_A, W_SU_WA and W_SU_P as follows:

Wellness-Substance Use-Alcohol Misuse (W_SU_A)=Wr₉

Wellness-Substance Use-Work Related Alcohol (W_SU_WA)=Wr₁₀

Wellness-Substance Use-Prescription Misuse (W_SU_P)=Wr₁₁

For calculating total scores for each of the seven subscale scores, all 39 items are scored.

With each HPC profile, feedback is provided in 5 different areas:
(1) Program Profile Match
(2) Key Risk Areas
(3) Key Strength Areas
(4) Total Risk/Strength Score
(5) Customized or Hybrid Considerations:

The feedback page is represented as follows:

HPC Index ™ Profile Interpretation

```
Each profile provides a unique glimpse into the climate of the workplace.
The accuracy of the profile is based on how many participants completed
the survey. This profile is based on [NUMBER_OF_PARTICIPANTS]
participants. The feedback below lets you know the following: (1) whether
a particular program in the IntelliPrev ™ library may be most suitable to
your setting or whether you might need to consider a customized or hybrid
option where you build a program yourself from different IntelliPrev ™
components; (2) your key risk and strength areas; and (3) the total
risk/strength score.
(1) Program Profile Match
    <enter text>
(2) Key Risk Areas
    <enter text>
(3) Key Strength Areas
    <enter text>
(4) Customized or Hybrid Considerations:
    <enter text>
```

### A. Profile Match for the “Wellness Outreach at Work” Program

The text response for this includes three variable fields: (1) main response, (2) wellness weights response; and (3) wellness committee suggestions. With regards to the main response two conditions are required for a profile match:

[(W<20) or (W_P<13) or (W_S<13)] and [(C<21) or (T<24)] C1

AND

[(W<C) and (C<T) and (T<S)] or [(W<C) and (C<A) and (A<S)] C2

As shown above, the formula includes two components (C1 and C2 are each required). The formula C1 includes two components (C1.1 and C1.2 are each required):
C1.1 The Health & Wellness (W) score is less than 20 points, OR the Wellness-Physical (W_P) subscale score is less than 13, OR the Wellness-Substance Use (W_SU) subscale score is less than 13; AND
C1.2 The Coping with Stress (C) score is less than 21 OR the Team Communication (T) score is less than 24.

The formula C2 includes two components (either C2.1 or C2.2 is required):
C2.1 The Health & Wellness (W) score is less than the Coping with Stress (C) score AND the Coping with Stress (C) score is less than the Team Communication (T) score AND the Team Communication (T) score is less than the Help & Support (S) score; OR
C2.2 The Health & Wellness (W) score is less than the Coping with Stress (C) score AND the Coping with Stress (C) is less than the Policy and Accountability (A) score AND the Policy and Accountability (A) score is less than the Help & Support (S).

As an example of a profile match, the user is presented with the following text with the variable text:

```
Your profile indicates that your workplace [DEGREE] benefit from the “Wellness Outreach at
Work” model. Responses suggest workers have problems maintaining a physically healthy
lifestyle, stress and/or the lack of teamwork. In reviewing this model keep in mind that it is a
strategic approach that often involves setting up a wellness committee. The program focuses on
health professionals who conduct one-on-one wellness coaching with workers. These health
professionals use different protocols depending on the specific needs of workers.
Your specific profile suggests the following protocols are indicated. Outreach or Wellness
counselors may want to prepare protocols for those indicated below. The response below
indicates how likely the intervention protocol will help
    Weight Management: [MANAGEMENT]
    Cholesterol: [CHOLESTEROL]
    Physical Fitness: [PHYSICAL_FITNESS]
    Smoking Cessation: [SMOKING_CESSATION]
    Alcohol Reduction: [ALCOHOL_REDUCTION]
    Multiple Cardiovascular: [MULTIPLE_CARDIOVASCULAR]
Also, there is a [W_COM] need for a Wellness Committee or for improvement of the committee.
If you already have a Wellness Committee in place, the Wellness Outreach Program might be
able to help you. Visit the IntelliPrev ™ Wellness Library to learn more about this program.
```

Where the variable text (DEGREE) above is replaced with:

| | |
|---|---|
| “would greatly” | if (C + W) < 20 |
| “would” | if (C + W) ≧ 21 and ≦ 29 |
| “is likely to” | if (C + W) > 29 |

“Yes, Very Likely to help” replaces the variable text items below under the following conditions (C1):
MANAGEMENT: if (Wr₁≦2.5) or (Wr₂≦2.5)
CHOLESTEROL: if (Wr₂≦2.5)
PHYSICAL_FITNESS: if (Wr₃≦2.5) or (Wr₄≦2.5)
SMOKING_CESSATION: if (Wr₈≦2.5)
ALCOHOL_REDUCTION: if (Wr₉≦3) or (Wr₁₀≦3)
MULTIPLE_CARDIOVASCULAR: when more than one of the above are true

“Yes, Fairly Likely to help” replaces the variable text items below under the following conditions (C2):
MANAGEMENT: if (Wr₁≦3.5) or (Wr₂≦3.5)
CHOLESTEROL: if (Wr₂≦3.5)
PHYSICAL_FITNESS: if (Wr₃≦3.5) or (Wr₄≦3.5)
SMOKING_CESSATION: if (Wr₈≦3.5)
ALCOHOL_REDUCTION: if (Wr₉≦4) or (Wr₁₀≦4)
MULTIPLE_CARDIOVASCULAR: when more than one of the above are true

“Not Likely to help” replaces the variable text items where the C1 and C2 conditions are not met.

The Wellness Committee (W_COM) subscale is calculated using the following formula:

W_COM=(Tr₃+Bs₁+As₃+Ar₃+Ss₂+Sr₃)

Where the variable text (W_COM) above is replaced with:

| | |
|---|---|
| “low” | if (W_COM) > 20 |
| “moderate” | if (W_COM) >= 15 and <= 19 |
| “fairly strong” | if (W_COM) >= 10 and <= 14 |
| “very strong” | if (W_COM) < 10 |

B. Profile Match for the “Coping with Work/Family Stress” Program

The text response for this includes three variable fields: (1) main response, and (2) five module emphasis. With regards to the main response three conditions are required for a profile match:

[B<20 or C<20] and (B+C<40) C1

AND

[(B≦W) or (C≦W)] or [(W_ME<12) or (W_SU<15)] C2

AND

[(W≦T or W≦P) and (T<S or P<S)] C3

As shown above, the formula includes three components (C1, C2 and C3 are each required):
C1 The Work-Life Balance (B) score is less than 20 points, OR the Coping with Stress (C) score is less than 20; AND the sum of the Work-Life Balance (B) and the Coping with Stress (C) score is less than 40 points; AND
C2 The Work-Life Balance (B) score is less than the Health & Wellness (W) score OR the Coping with Stress (C) score is less than the Health & Wellness (W) score; OR The Wellness-Mood/Energy (W_ME) subscale score is less than 12 OR the Wellness-Substance Use (W_SU) subscale score is less than 15; AND
C3 The Health & Wellness (W) score is less than the Team Communication (T) score OR the Health & Wellness (W) score is less than the Team Communication (P) score; AND either the Team Communication (T) score OR the Team Communication (P) score is less than the Help & Support (S) score.

The user is presented with the following text with the variable text:

(The profile generated from your response fits a pattern of risks and strengths that may be
addressed by a program in the IntelliPrev ™ Wellness Library. After reading the profile
interpretation below, please consult the library for more information.)
Your profile indicates that your workplace [DEGREE] benefit from the “Coping with Work &
Family Stress” program. Responses suggest dual problems in the area of personal stress and
work-life balance. In reviewing this model keep in mind that it has five different modules
designed to prevent stress-related problems in workers, including decreasing psychological
symptoms (depression, anxiety, and somatic complaints) and promoting healthy lifestyles. The
program is designed for all modules to be used together across 16 sessions. However, efficiency
or strategic concerns might lead you to consider emphasis or focus on certain modules.
Your total score from the use of HPC ratings suggests: [SUGGESTION]
Visit the IntelliPrev ™ Wellness Library to learn more about this program.

Where the variable text (DEGREE) above is replaced with:

| | |
|---|---|
| “would greatly” | if (B + C) < 20 |
| “would” | if (B + C) ≧ 21 and ≦ 29 |
| “is likely to” | if (B + C) > 29 |

The variable text (SUGGESTION) above is inserted under the following conditions:

| | |
|---|---|
| emphasis on ‘Problem-Solving’ module. | if (W > 14) AND |
| Participants will learn a problem-solving | ((Br₂ < 3.5) OR |
| process to address stressors that arise in their | (Br₃ < 3.5)) |
| work, family, and work/family domains | |
| emphasis on ‘Promoting Effective | if (W > 14) AND |
| Communication’ module. Participants will | (T < 14) |
| learn effective and ineffective communication | |
| strategies, different styles of communicating, | |
| as well as practice learned skills. | |
| emphasis on ‘Social Support’ module. | if (S < 14) |
| Participants learn the varied ways that social | |
| support serves to modify stressors and stress | |
| reactions, and to increase their use of effective | |
| coping strategies. | |
| emphasis on ‘Cognitive Restructuring & Self- | if (T > 17) AND |
| Monitoring.’ Participants learn a range of | (S > 17) |
| cognitive coping strategies, including the use | AND (Ss₁ ≦ 4) AND |
| of self-monitoring as a means to promote | (W_ME < 12) |
| behavior change. They apply these strategies | |
| to modify their eating and exercise patterns, | |
| and to reduce their substance use (including | |
| alcohol, drugs, and tobacco) and other problem | |
| behaviors. | |
| emphasis on ‘Stress Management: Healthy | if (C + W) < 27 |
| Lifestyles and Stress Reduction.” Participants | |
| are taught a broad range of stress management | |
| techniques is introduced, including deep | |
| breathing, muscle relaxation, creative | |
| visualization, and others. | |
| use of all modules with no specific emphasis | if none of the conditions |
| on any given module. | above are met |

### C. Profile Match for the “Healthy Workplace” Program

The text response for this includes three variable fields: three variable fields: (1) main response, (2) make the connection; and (3) prime life 2000. With regards to the main response three conditions are required for a profile match:

[(W<22) and (C<22)] and (W+C<40)

OR

[(W_{R9}<3.5) or (W_{R10}<3.5) or (W_{R10}<3.5)] and (W+C<40) C2

AND

{(W<C) and [(C<S) or (C<B)]} and (S+B<50) C3

Wellness-Substance Use-Alcohol Misuse (W_SU_A)=Wᵣ₉

Wellness-Substance Use-Work Related Alcohol (W_SU_WA)=Wᵣ₁₀

Wellness-Substance Use-Prescription Misuse (W_SU_P)=Wᵣ₁₁

As shown above, the formula includes two components (either C1 or C2, and C3 are required):
C1 The Health & Wellness (W) score is less than 22 points, AND the Coping with Stress (C) score is less than 22; AND the sum of the Health & Wellness (W) score and the Coping with Stress (C) score is less than 40; OR
C2 At least one of the Wellness-Substance Use-Alcohol Misuse (W_SU_A) or the Wellness-Substance Use-Work Related Alcohol (W_SU_WA) or the Wellness-Substance Use-Prescription Misuse (W_SU_P) responses is less than 3.5, AND the sum of Health & Wellness (W) score and the Coping with Stress (C) score is less than 40; AND
C3 The Health & Wellness (W) score is less than the Coping with Stress (C) score; AND the Coping with Stress (C) score is less than the Help & Support (S) OR the Coping with Stress (C) score is less than the Work-Life Balance (B) score; AND the sum of the Help & Support (S) score and the Work-Life Balance (B) score is less than 50.

The user is presented with the following text with the variable text:

(The profile generated from your response fits a pattern of risks and strengths that may be
addressed by a program in the IntelliPrev ™ Wellness Library. After reading the profile
interpretation below, please consult the library for more information.)
Your profile indicates that your workplace [DEGREE] benefit from the “Healthy Workplace”
model. In reviewing this model, keep in mind that it is actually a set of workplace substance
abuse prevention interventions that reduce unsafe drinking, illegal drug use, and prescription
drug abuse while improving the health practices of adult workers. The Healthy Workplace
program consists of five interventions that are delivered in small group sessions without
requiring large amounts of time off the job. Results from your profile may distinguish whether
any of the “Healthy Workplace” programs should be used. They may also point to using the
“Make the Connection” program or the “Prime Life 2000.” These programs are especially
indicated if you already have a wellness program in place. Please consult the IntelliPrev ™
Wellness Library for more information about these programs. The program developer provides
technical assistance to help you best select from among the different programs.
[SUGGESTION]

Where the variable text (DEGREE) above is replaced with:

| | |
|---|---|
| “would greatly” | if (C + W) < 22 |
| “would” | if (C + W) ≧ 23 and ≦ 31 |
| “is likely to” | if (C + W) > 32 |

The variable text (SUGGESTION) above is inserted under the following conditions:

| | |
|---|---|
| The responses to items on your profile suggests | W < 17 and [(Wr₉ < 3.5) |
| that you might benefit from the video-based | or (Wr₁₀ < 3.5) or |
| series, titled “Make the Connection.” This | (Wr₁₁ < 3.5)] |
| three-part series of video and print materials is | |
| designed for insertion into workplace health | |
| promotion programs on stress management, | |
| weight management/nutrition, and fitness. This | |
| program helps you address substance abuse | |
| risks in a non-stigmatized way by addressing | |
| such problems as wellness issues. | |
| Your scores indicate that you may want to | |
| focus on: [ADDITIONAL_SUGGESTIONS] | |

The variable text (ADDITIONAL_SUGGESTIONS) above is inserted under the following conditions:

| | |
|---|---|
| the Stress Connection | if C < 20 or S < 20 or B < 20 |
| the Healthy Eating connection | if Wr₁ < 3.5 or Wr₂ < 3.5 |
| the Active Lifestyle Connection | if Wr₃ < 3.5 or Wr₄ < 3.5 |
| Your scores indicate you may want | if all of the conditions above are met |
| to consider all three parts. | |

### D. Profile Match for the “Team Awareness” Program

The text response for this includes three variable fields: (1) main response; (2) emphasis on one of three module combinations within Team Awareness (Relevance, Policy and Tolerance) (Communication and Peer Referral) (Stress). With regard to the main response, three conditions are required for a profile match:

(T<20) and (A<21) and (S<21) C1

OR

(T<A) or (T<S) C2

AND

(W_SU<15) C3

As shown above, the formula includes two components (either C1 or C2, and C3 are required):
C1 The Team Communication (T) score is less than 20, AND the Policy and Accountability (A) score is less than 21; AND the Help & Support (S) score is less than 21; OR
C2 The Team Communication (T) score is lower than either the Policy and Accountability (A) score or the Help & Support (S) score; AND
C3 The (4-item) Wellness-Substance Use (W_SU) subscale score is less than 15.

The user is presented with the following text with the variable text:

(The profile generated from your response fits a pattern of risks and strengths that may be
addressed by a program in the IntelliPrev ™ Wellness Library. After reading the profile
interpretation below, please consult the library for more information.)
Your profile indicates that your workplace [DEGREE] benefit from the “Team Awareness”
model. This is an innovative program in employee team-building, policy-learning,
communication and peer referral that can help increase help-seeking and utilization of EAP
programs as well as reduce safety risks and problem drinking. You would receive this profile
match if there are dual risks for substance abuse and poor communication or social support.
Team Awareness consists of six modules that are delivered in small group sessions without
requiring large amounts of time off the job. However, efficiency or strategic concerns might
lead you to consider emphasis or focus on certain modules. A supervisor module may be
especially helpful when communication is operating at risky levels. Consult the IntelliPrev ™
Wellness Library to learn more about Team Awareness modules. The program developer
provides technical assistance to help you best customize this program.
Total scores from your HPC ratings suggest [SUGGESTION]

Where the variable text (DEGREE) above is replaced with:

| | |
|---|---|
| “would greatly” | if (T + W_SU) < 22 |
| “would” | if (T + W_SU) ≧ 23 and ≦ 31 |
| “is likely to” | if (T + W_SU) > 32 |

The variable text (SUGGESTION) above is inserted under the following conditions:

| | |
|---|---|
| emphasis on ‘Policy Training.’ You may wish | if (A < 15) |
| to focus on the first two modules of Team | |
| Awareness: Relevance and Policy (The Risks | |
| & Strengths Game). You may also just deliver | |
| the Policy Module. These modules will help | |
| you train workers on drug free workplace | |
| policy in a fun, interactive manner and increase | |
| their interest in making the workplace both safe | |
| and drug-free. | |
| emphasis on ‘Communication and Peer | if (T < 15) or (S < 15) |
| Referral Training.’ You may wish to focus on | |
| different communication tools in Team | |
| Awareness and emphasize the last two | |
| modules on Workplace Communication and | |
| Peer Referral. These modules can help reduce | |
| stigma to using the EAP and increase worker | |
| capacity for encouraging coworkers or family | |
| members to get help: | |
| emphasis on ‘Tolerance and Stress’ Training. | if (C < 15) |
| You may wish to focus on these modules that | |
| invite workers to look at how much they | |
| tolerate problems in their lives and the stress it | |
| causes them. | |
| use of all six modules with no specific | if all of the conditions |
| emphasis. These six modules are Relevance, | above are met |
| Policy, Tolerance, Stress & Problem Solving, | |
| Communication, and Peer Referral (NUDGE). | |

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A health and wellness system, comprising:
a network configured to provide one or more members of an organization access to the health and wellness system;
a web server configured to provide a plurality of web pages over the network, wherein a survey having a plurality of health and wellness categories is delivered to the one or more members via the plurality of web pages, the one or more members provide a response to the survey having a plurality of numerical scores for each of the plurality of health and wellness categories; and
a plurality of wellness programs, wherein each of the plurality of wellness programs is configured to improve the health and productivity in at least one of the plurality of health and wellness categories for at least one of the one or more members, each of the plurality of wellness programs has a predefined mathematical equation for each of the plurality of health and wellness categories, and wherein one or more of the plurality of wellness programs are identified in a readable format via the plurality of web pages by comparing results from the predefined mathematical equations using the plurality of numerical scores as input.

2. The system of claim 1, wherein the predefined mathematical equations are derived from numerical ratings in each of the plurality of health and wellness categories provided by respective developers of the plurality of wellness programs.

3. The system of claim 1, wherein the plurality of health and wellness categories comprise at least one selected from the group consisting of a Health & Wellness category, a Work-Life Balance category, a Presence & Engagement category, a Team Communication category, a Policy & Accountability category, a Coping with Stress category and a Help & Support category.

4. The system of claim 1, wherein the one or more members comprise at least one selected from the group consisting of employees and managers.

5. The system of claim 1, wherein the numerical scores for each of the plurality of health and wellness categories comprise a plurality of strength scores and a plurality of risk scores.

6. The system of claim 1, wherein the readable format comprises a graphical chart displayed via the plurality of web pages.

7. The system of claim 1, wherein the readable format comprises a text message displayed via the plurality of web pages.

8. The system of claim 1, wherein one or more of the identified programs comprise programs delivered to the one or more members, and wherein each delivered program has an associated effectiveness score.

9. The system of claim 8, wherein the effectiveness scores are based on reductions in cost to the organization attributable to the respective delivered programs.

10. The system of claim 8, wherein the effectiveness scores are based responses to a survey given to at least one of the one or more members.

11. The system of claim 8, wherein the predefined mathematical equations are iteratively improved over time based on the effectiveness scores.

12. The system of claim 8, wherein the survey is iteratively improved over time based on the effectiveness scores.

13. A method providing a health and wellness program to members of an organization, comprising:
maintaining a web server configured to provide a plurality of web pages over a network;
defining a mathematical equation in each of a plurality of health and wellness categories for each of a plurality of wellness programs, wherein each of the plurality of wellness programs is configured to improve the health and productivity in at least one of the plurality of health and wellness categories for at least one of the one or more members;
providing a survey for each of the plurality of health and wellness categories to the one or more members via the plurality of web pages;
receiving a response to the survey from the one or more members, wherein the response comprises a plurality of numerical scores for each of the plurality of health and wellness categories;
comparing results from the mathematical equations using the plurality of numerical scores as input;
identifying in a readable format one or more of the plurality of wellness programs via the plurality of web pages based comparison; and
delivering at least one of the identified programs to at least one of the one or more members.

14. The method of claim 13, wherein the plurality of health and wellness categories comprise at least one selected from the group consisting of a Health & Wellness category, a Work-Life Balance category, a Presence & Engagement category, a Team Communication category, a Policy & Accountability category, a Coping with Stress category and a Help & Support category.

15. The method of claim 13, further comprising determining a numerical effectiveness score for each of the delivered programs.

16. The method of claim 15, wherein the determining the numerical effectiveness score comprises evaluating the reductions in cost to the organization attributable to the respective delivered program.

17. The method of claim 15, wherein the effectiveness scores are based responses to a survey given to at least one of the one or more members for each of the delivered programs.

18. The method of claim 15, further comprising iteratively improving the mathematical equations over time based on the effectiveness scores.

19. The method of claim 13, further comprising providing health and wellness e-Learning via the plurality of web pages.
